(19) United States
(12) Patent Application Publication
(10) Pub. No.: US 2022/0235782 A1
(43) Pub. Date: Jul. 28, 2022

(54) AIRFLOW DEVICE

(71) Applicant: Beacon Lighting International Limited, Hong Kong (HK)

(72) Inventors: Joe VILLELLA, South Morang, Victoria (AU); Neil WALDBAUM, Currimundi, QLD (AU)

(21) Appl. No.: 17/616,997

(22) PCT Filed: Jun. 2, 2020
(86) PCT No.: PCT/AU2020/050557

§ 371 Date: Dec. 6, 2021

(30) Foreign Application Priority Data
Jun. 7, 2019 (AU) 2019 901985
Nov. 22, 2019 (AU) 2019 904429

(51) Int. Cl. F04D 25/08; F04D 17/16; F04D 25/06; F04D 29/32; F04D 29/42; F04D 29/44; F04D 29/54; F04D 29/66; F21V 33/00; F24F 3/056

(52) U.S. Cl. CPC F04D 25/088; F21Y 2105/18; F04D 25/06; F04D 29/329; F04D 29/4226; F04D 29/441; F04D 29/541; F04D 29/663; F04D 29/666; F04D 29/667; F21V 33/0096; F24F 3/056; F05D 2210/12; F05D 2250/71; F05D 2270/173; F04D 17/16

(57) ABSTRACT

An airflow device including: (i) airflow generating means for generating first and second streams of air; (ii) first and second Coanda surfaces; (iii) means for directing the first and second streams of air over first and second Coanda surfaces respectively; and wherein (iv) the first stream of air leaving the first Coanda surface is directed so as to pass over the second Coanda surface.

### BACKGROUND OF IRE INVENTION

This invention relates to an airflow device and, more specifically, to a ceiling-mountable fan.

Conventional ceiling fans are mounted in a suspended manner to a ceiling and typically have a set of motorised blades rotatable about a vertical axis to provide downward airflow. Such ceiling fans are structurally bulky and occupy a significant portion of an interior with elongated fan blades, which can be unsightly and difficult to clean. Furthermore, the exposed moving fan blades may pose a risk of injury. Movement of the fan blades during use can be noisy and disturbing in home and office environments, and do not typically produce airflow that is felt uniformly around a room.

The applicant has determined that it would be advantageous to provide a ceiling-mountable fan with improved aesthetic and functional performances. The present invention, in its preferred embodiments, seeks to at least in part alleviate one or more of the above-identified problems.

### SUMMARY OF THE INVENTION

According to a first aspect of the invention there is provided an airflow device including:
(i) airflow generating means for generating first and second streams of air;
(ii) first and second Coanda surfaces;
(iii) means for directing the first and second streams of air over first and second Coanda surfaces respectively; and wherein
(iv) the first stream of air leaving the first Coanda surface is directed so as to pass over the second Coanda surface.

Preferably the airflow generating means generates three or more streams of air and each stream of air is directed over respective Coanda surfaces, the arrangement being such that streams of air leaving upstream Coanda surfaces are directed over adjacent downstream Coanda surfaces.

It has been found that increased airflow can be achieved by using multiple Coanda surfaces effectively operating in series.

Preferably, the first Coanda surface is positioned above the second Coanda surface so as to define an outlet therebetween, and wherein a stream of air is directed by said directing means so as to pass through the outlet and over the second Coanda surface.

Preferably, an opening of the outlet has a height of about 20 mm or less.

Preferably, the first and second Coanda surfaces are positioned relatively offset to the second Coanda surface.

Preferably, the first and second Coanda surfaces partially overlap when seen from a plan view.

Preferably, at least one of the first and second. Coanda surfaces is convex in shape. Preferably, all Coanda surfaces are convex in shape. Preferably, a radius of the convex curvature is about 380 mm.

Alternatively, at least one of the first and second Coanda surfaces is flat. Alternatively, all Coanda surfaces are flat.

Preferably, the first and second Coanda surfaces extend downwardly with an angle of less than 90° relative to a vertical axis. Preferably, the downward extending angle of the first Coanda surface is between about 20° and 25° relative to a vertical axis. Preferably, the downward extending angle of the second Coanda surface is between about 30° and 35° relative to a vertical axis.

Preferably, the Coanda surfaces are provided on respective vanes configured in the form of annular frames. Preferably, the respective vanes are coaxially mounted relative to each other.

Preferably, the vane of the first Coanda surface has a smaller diameter than that of the vane of the second Coanda surface.

Preferably, the Coanda surfaces of the vanes have a minimum width in the radial direction of about 390 mm.

Preferably, one or more guide(s) are arranged in the outlet between the first and second Coanda surfaces so as to direct a stream of air passing over the second Coanda surface in an outward direction. Preferably, the outward direction is a radial angle of 90° with respect to a tangent of an outer edge of the second Coanda surface.

Preferably, the airflow generating means is an impeller driven by an electric motor. Preferably, the air inlet is positioned above the impeller for entraining airflow located above the impeller.

Preferably, the airflow generating means is configured to generate an initial stream of airflow which is divided into the first and second streams of air by a dividing portion located in a path of the initial stream of airflow.

Preferably, the device is substantially enclosed in a housing having an air inlet upstream of the Coanda surfaces and an air outlet downstream of the Coanda surfaces.

According to another aspect of the present invention, there is provided a ceiling-mountable fan comprising an airflow device as described above and means for mounting the airflow device to a ceiling.

According to second aspect of the invention there is provided a ceiling fan including: a housing having an outlet; an impeller located within the housing for producing a stream of air passing through the outlet; a first Coanda surface positioned in or adjacent to the outlet and arranged such that said stream of air passes over the Coanda surface and wherein ambient air is, in use, entrained into said stream of air; a second Coanda surface positioned adjacent to the first Coanda surface so that said stream of air leaving the first Coanda surface is directed to pass over the second Coanda surface.

Preferably, the fan further comprises a first vane and a second vane mounted such that they are located, in use, in said stream of air, and wherein the first and second Coanda surfaces are respectively located on the first and second vanes. Preferably, the fan comprises additional one or more vanes mounted such that they are located, in use, in said stream of air. Preferably, each of the additional one or more vanes includes a Coanda surface, each of which operates to direct air towards a successive one of said Coanda surfaces. Preferably; the or each vane is coaxially mounted to the housing.

Preferably, the impeller is substantially concealed by the housing and the vane(s), in use.

Preferably, the or each vane is configured in the form of an annular frame.

Preferably, each of the vanes includes a Coanda surface, each of which operates to direct air towards a successive one of said Coanda surfaces. Alternatively, the fan comprises two or more said vanes having respective Coanda surfaces. Alternatively, the fan comprises three or more said vanes having respective Coanda surfaces.

Preferably, the Coanda surfaces are vertically arranged relative to each other. Preferably, the downward extending angle of a higher Coanda surface is between about 20° and 25° relative to a vertical axis. Preferably, the downward extending angle of a lower Coanda surface is between about 30° and 35° relative to a vertical axis.

Preferably, the Coanda surfaces are offset in a radial direction relative to each other. Preferably, the Coanda surfaces are disposed parallel with respect to each other. Preferably, the Coanda surfaces partially overlap when seen from a plan view.

Preferably, each successive vane has a larger diameter than that of the housing or a preceding vane.

Preferably, one or more guide(s) are arranged in the outlet between adjacent Coanda surfaces so as to direct a stream of air to pass over a downstream Coanda surface in an outward direction. Preferably, the outward direction is at a radial angle of 90° with respect to a tangent of an outer edge of the second Coanda surface.

Preferably, the respective Coanda surface of the or each vane has a minimum width in the radial direction of about 390 mm.

Preferably, at least one of the Coanda surfaces is convex in shape. Preferably, all Coanda surfaces are convex in shape. Preferably, a radius of the convex curvature is about 380 mm.

Alternatively, at least one of the Coanda surfaces is flat. Alternatively, all Coanda surfaces are flat.

Preferably, the Coanda surfaces extend downwardly with an angle of less than 90° relative to a vertical axis. Preferably, the or each Coanda surface forms part of an outer surface of the housing or the vanes.

Preferably, an opening of the outlet has a height of about 20 mm or less.

Preferably, the fan includes mounting means for mounting the fan to a ceiling and an inlet which is, in use, located adjacent to the ceiling. Preferably, the inlet is located above an impeller for drawing ambient air in an downward direction toward the impeller.

Preferably, the housing includes a base wall and wherein a light fitting is located adjacent to the base wall.

According to another aspect of the present invention, there is provided a ceiling fan including: a housing having an outlet; an impeller located within the housing for producing a stream of air passing through the outlet; two or more vanes configured in the form of annular frames mounted coaxially to the housing such that they are located, in use, in said stream of air, each vane comprising a flat surface positioned in or adjacent to the outlet and arranged such that said stream of air passes over the flat surface and directed towards a successive one of said flat surfaces.

Preferably, each flat surface extends downwardly with an angle of less than 90° relative to a vertical axis.

Preferably, the flat surfaces are offset in a radial direction relative to each other. Preferably, the flat surfaces partially overlap when seen from a plan view.

Preferably, the impeller is substantially concealed by the housing and the vanes, in use.

Preferably, the fan includes mounting means for mounting the fan to a ceiling and an inlet which is, in use, located adjacent to the ceiling.

Preferably, the housing includes a base wall and wherein a light fitting is located adjacent to the base wall.

According to yet another embodiment of the present invention, there is provided a ceiling fan including: a housing having an outlet; an impeller located within the housing for producing a stream of air passing through the outlet; two or more vanes configured in the form of annular frames mounted coaxially to the housing such that they are located, in use, in said stream of air, each vane comprising a deflecting surface positioned in or adjacent to the outlet and arranged such that said stream of air passes over the deflecting surface and directed towards a successive one of said deflecting surfaces.

Preferably, each deflecting surface extends downwardly with an angle of less than 90° relative to a vertical axis.

Preferably, the deflecting surfaces are offset in a radial direction relative to each other. Preferably, the deflecting surfaces partially overlap when seen from a plan view.

Preferably, the impeller is substantially concealed by the housing and the vanes, in use.

Preferably, the fan includes mounting means for mounting the fan to a ceiling and an inlet which is, in use, located adjacent to the ceiling.

Preferably, the housing includes a base wall and wherein a light fitting is located adjacent to the base wall. Preferably, the inlet is located above an impeller for drawing ambient air in an downward direction toward the impeller.

According to another aspect of the present invention, there is provided a ceiling fan including a housing having an outlet; an impeller located within the housing for producing a stream of air passing through the outlet; and a plurality of Coanda surfaces positioned in or adjacent to the outlet and arranged such that said stream of air passes over the Coanda surface and wherein ambient air is, in use, entrained into said stream of air. Wherein each of the Coanda surfaces operates to direct air towards a successive one of said Coanda surfaces.

According to another aspect of the present invention, there is provided an impeller for an airflow device, comprising: a plurality of longitudinally extending blades evenly disposed on a hub member, the blades being configured to radiate outwardly, from a raised centre of hub member, along an continuous arcuate path, wherein the arcuate path follows a chord angle of between 30° and 40°.

Preferably, each of the plurality of blades comprises a root portion, which is located at or proximate a root end portion of the blade, a body portion and a tip end portion, and wherein the blade is configured so that its height remains constant for a root end portion of the blade and gradually reduces along the length of the blade from the body portion toward the tip end portion of the blade.

Preferably, at least one of the blades comprises a step along a spine of the blade at or proximate a tip end portion of the blade.

Preferably, at least one of the blades is configured with a forward leaning edge at or proximate a root end portion of the blade and a backward leaning edge; at or proximate a tip end of the blade.

Preferably, the plurality of blades follow an anti-clockwise arcuate path with respect to the centre of the hub member when viewed from above.

Preferably, a tip end of each of the plurality of blades extends beyond a peripheral edge of the hub member.

Preferably, the impeller hub member is configured with a diameter of about 400 mm.

Preferably, the centre of the hub member is configured with a dome having a diameter of 90 mm.

Preferably, the hub member is configured with a cavity for housing a motor unit.

In a preferred embodiment of the invention, the airflow device is formed as a ceiling fan/light which has a curved cylindrical housing which can be made to have an attractive appearance. Part of the curved cylindrical surface functions as a Coanda surface and one or more vanes can be included so as to produce enhanced airflow because of the compound effect of the coanda surfaces. The compound Coanda surfaces also function to entrain more ambient air into the stream of air which leaves the outlet of the housing.

### BRIEF DESCRIPTION OF THE DRAWINGS

The invention will now be further described with reference to the accompanying drawings, in which:

FIG. 1 is a schematic view of a ceiling fan/light constructed in accordance with the invention,

FIG. 2 is a perspective view of the fan/light shown in FIG. 1;

FIG. 3 is a schematic cross-sectional view through the fan/light;

FIG. 4 is a cross-sectional view showing streams of entrained ambient air;

FIG. 5 is a schematic view of a fanlight housing which includes multiple Coanda surfaces;

FIG. 6 is a side view of the housing shown in FIG. 5;

FIG. 7 is an enlarged fragmentary view of part of the housing shown in FIG. 6;

FIG. 8 is a schematic diagram showing enhanced airflows produced by the compound Coanda surfaces;

FIG. 9 is a schematic view of a further embodiment of the fan/light;

FIG. 10 is a fragmentary cross-sectional view through the fan/light shown in FIG. 9;

FIG. 11 is a perspective view showing a ceiling fan assembly in accordance with a further embodiment of the present invention;

FIG. 12 is a perspective view showing the ceiling fan assembly of FIG. 11 from above;

FIG. 13 is a side view of the ceiling fan assembly of FIG. 11;

FIG. 14 is a plan view of the ceiling fan assembly of FIG. 11;

FIG. 15 is a bottom view of the ceiling fan assembly of FIG. 11;

FIG. 16 is a sectional view of the ceiling fan assembly shown in FIG. 13;

FIG. 17 is a partial close up sectional schematic side view of the fan assembly of FIG. 13 showing the streams of airflow relative to surfaces of the fan assembly;

FIG. 18 is an exploded view from above showing the ceiling fan assembly of FIG. 11:

FIG. 19 is an exploded view from below showing the ceiling fan assembly of FIG. 11;

FIG. 20 is a plan view of an impeller for use with the ceiling fan in accordance with a preferred embodiment of the invention;

FIG. 21 is a side view of the impeller of FIG. 20;

FIG. 22 is a perspective view of the impeller of FIG. 20 when mounted within a fan assembly embodying the present invention;

FIG. 23 is a perspective close up side view of the impeller of FIG. 22;

FIG. 24 is a partial sectional schematic plan view of a fan assembly according to another embodiment of the present invention;

FIG. 25A is a schematic showing CFD flows in an initial air flow phase for fan assemblies embodying the present invention having one, two and three Coanda vanes;

FIG. 25B is a schematic showing CFD flows of the fan assemblies of FIG. 25A in a secondary air flow phase;

FIG. 25C is a schematic showing CFD flows of the fan assemblies of FIG. 25A in a tertiary air flow phase;

FIG. 26 is a perspective view showing an impeller and vane housing assembly according to another embodiment of the present invention;

FIG. 27 is a plan view of the impeller and housing assembly of FIG. 26;

FIG. 28 is a side view of the impeller and housing assembly of FIG. 26;

FIG. 29 is a sectional view of the impeller and housing assembly of FIG. 28;

FIG. 30 is a plan view of an impeller in accordance with another embodiment of the present invention;

FIG. 31 is a side view of the impeller as shown in FIG. 30;

FIG. 32 is a perspective view of the impeller of FIG. 30;

FIGS. 33 to 39 show a plan view of the impeller of FIG. 30 and six sectional views of the impeller as indicated in FIG. 33;

FIG. 40 is a perspective view showing an impeller and vane housing assembly according to another embodiment of the present invention;

FIG. 41 is a plan view of the impeller and housing assembly of FIG. 40;

FIG. 42 is a side view of the impeller and housing assembly of FIG. 40;

FIG. 43 is a sectional view of the impeller and housing assembly of FIG. 40;

FIG. 44 is a plan view of an impeller in accordance with another embodiment of the present invention;

FIG. 45 is a side view of the impeller as shown in FIG. 44;

FIG. 46 is a perspective view of the impeller of FIG. 44;

FIGS. 47 to 53 show a plan view of the impeller of FIG. 44 and six sectional views of the impeller as indicated in FIG. 47;

FIGS. 54 to 57 show various schematic views of an impeller with an isolated continuous blade in accordance with another embodiment of the present invention;

FIGS. 58 to 62 show CFD simulation outputs comparing different impeller configurations in relation to overall airflow velocity and noise pressure performances;

FIG. 63 shows various impeller blade configuration with different chord angles;

FIGS. 64 to 66 show CFD simulation outputs comparing impellers having different chord angles of FIG. 63 in relation to overall airflow velocity and noise pressure performances;

FIGS. 67 to 74 show CFD simulation outputs comparing different impeller and fan housing configurations in relation to airflow velocity and noise pressure performances;

FIGS. 75 to 77 show CFD simulation outputs comparing yet further impeller and fan housing configurations in relation to airflow velocity and noise pressure performances;

FIG. 78 is a perspective view showing an impeller and vane housing assembly according to another embodiment of the present invention;

FIG. 79 is a plan view of the impeller and housing assembly of FIG. 78;

FIG. 80 is a sectional view of the impeller and housing assembly of FIG. 78;

FIG. 81 is a plan view of an impeller in accordance with another embodiment of the present invention;

FIG. 82 is a side view of the impeller as shown in FIG. 81;

FIG. 83 is a perspective view of the impeller of FIG. 81; and

FIGS. 84 to 90 show a plan view of the impeller of FIG. 81 and six sectional views of the impeller as indicated in FIG. 84.

### DETAILED DESCRIPTION OF THE INVENTION

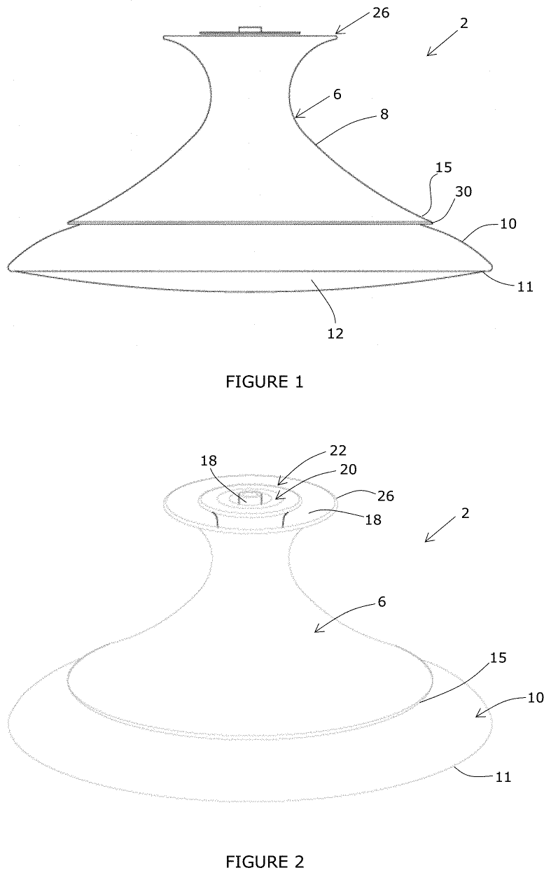

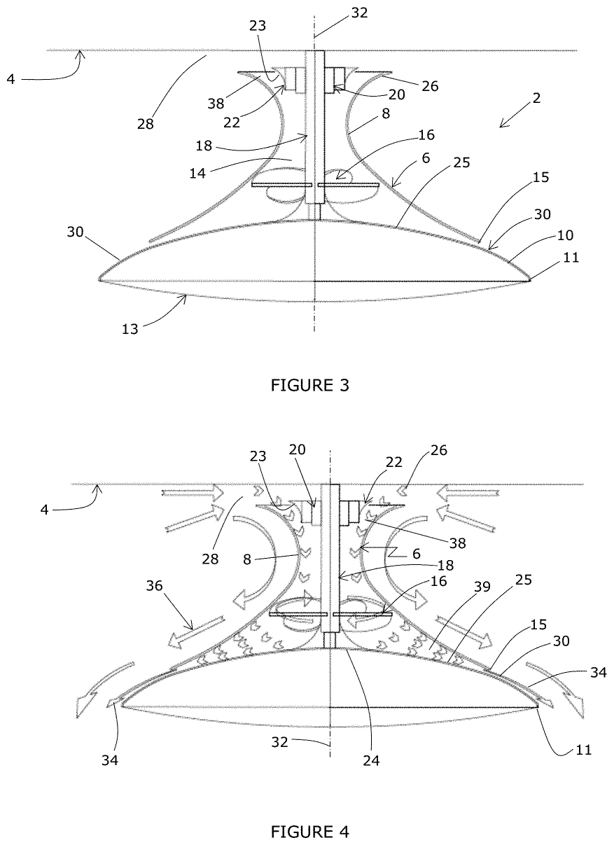

FIGS. 1 to 4 schematically illustrate a fan/light 2 constructed in accordance with the invention. In the illustrated arrangement, the fan/light 2 is adapted for mounting on a ceiling 4, as shown in FIGS. 3 and 4. The fan/light 2 includes a housing 6 which includes an upper housing portion 8 and a domed base wall 12. The domed base wall 12 has a lower rim 11 which extends beyond a lower rim 15 of the upper housing portion 8 and defines a Coanda surface 10 in the region which is laterally beyond the rim 15.

The fan/light 2 is provided with a light fitting 13 which is shown in broken lines in FIG. 3. The light fitting 13 can include an array of LED's with associated driving circuitry, fluorescent lamps or other light emitting elements. The light fitting 13 would typically include a translucent diffuser (not shown) so as to give the fan/light 2 an attractive appearance. Details of the light fitting 13 do not need to be described in detail as they can be the same as those commonly used in the art. It is preferred that the outer periphery of the light fitting 13 does not extend beyond the rim 11 so as to not have any influence on air flowing over the Coanda surface 10, as will be explained in more detail below.

The upper housing portion 8. Coanda surface 10 and domed base wall 12 form an internal chamber 14 within which is located an impeller 16. The impeller 16 is mounted on an impeller shaft 18 which is driven by an electric motor 20. It is preferred that the impeller shaft 18 is hollow so that it can carry electrical conductors (not shown) for the light fitting 13 in the usual way. The fan/light 2 includes a motor mounting bracket 22 which in use can be securely connected to the ceiling 4. In the illustrated arrangement, the bracket 22 includes a curved skirt 23 which in use extends from the ceiling 4 and inwardly towards the interior of the chamber 14. The lower end of the shaft 18 is connected to the base wall 12 by means of a bearing 24 which in the illustrated arrangement is connected to the upper surface 25 of the domed base wall 12.

In the illustrated arrangement, the upper rim 26 of the upper housing portion 8 is spaced from the ceiling 4 so as to define an inlet 28 to the chamber. The chamber 14 has an outlet 30 which is defined by a gap between the lower rim 15 of the upper housing portion 8 and the upper surface 25 of the base wall 12. The base wall 12 can be supported by means of ribs or brackets (not shown) connected between the upper housing portion 8 and the base wall 12 and within the chamber 14.

The basic operation of the fan/light 2 is such that the motor 20 drives the impeller 16 so that it rotates about impeller axis 32. This causes air to be drawn into the inlet 28 and pass out of the outlet 30. The internal surfaces of the chamber 14 and the shape of the gap between the upper housing portion 8 and the upper surface 25 of the base wall 12 is such that the stream of air 34 passing through the outlet 30 has laminar flow or substantially laminar flow. The stream of air 34 passing over the Coanda surface 10 experiences the Coanda effect so that it moves adjacent to the Coanda surface and is discharged into the room below in a generally downward and outward direction.

Because of the curved shape of the upper housing portion 8 and the Coanda surface 10, streams of entrained air 36 will be entrained into or adjacent to the stream of air 34 issuing from the outlet 30. This significantly increases airflow volumes so making the fan/light of the invention efficient. In the illustrated arrangement, the upper housing portion 8 is formed as a surface of revolution about the axis 32, although this is not essential. It is preferred, however, that the inner and outer surfaces of the housing 6 are aerodynamically shaped so as to enhance production of generally laminar flow from the outlet 30. The domed shape of the base wall 12 also enhances laminar flow from the outlet 30. The curved skirt 23 is preferably generally parallel to and spaced from the adjacent region of the upper housing portion 8 so as to define an inlet passage 38 and forms a generally smooth path for air entering the housing 6. It will also be appreciated from FIGS. 3 and 4 that the outlet passage 39 downstream of the impeller 16 is defined between the inner surface of the upper housing portion 8 and the upper surface 25 of the base wall 12 and tapers gradually towards the opening 30. This increases air speed and again promotes laminar flow.

The parts which form the housing 6 could be moulded from plastics material such as polystyrene or ABS. Alternatively, they could be formed from spun or pressed metal such as aluminium.

Various enhancements could be included in the fan/light, such as the addition of a heater, ioniser, air purifier and/or humidifier. Known techniques could also be adopted for reducing noise caused by the impeller and airflows to and from the housing 6. The techniques for incorporating these features in fans or fan/lights is known in the art and need not be described in detail.

In the fan/light 2 shown in FIGS. 1 to 4, there is a single Coanda surface 10. It has been found that significant improvement in performance can be obtained by providing one or more Coanda surfaces which effectively operate in series so as to lead to significantly higher volumes of ambient air which is entrained into the air flowing from the housing.

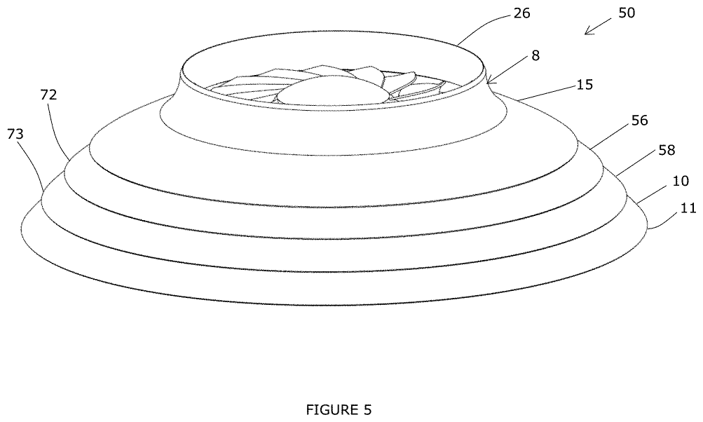

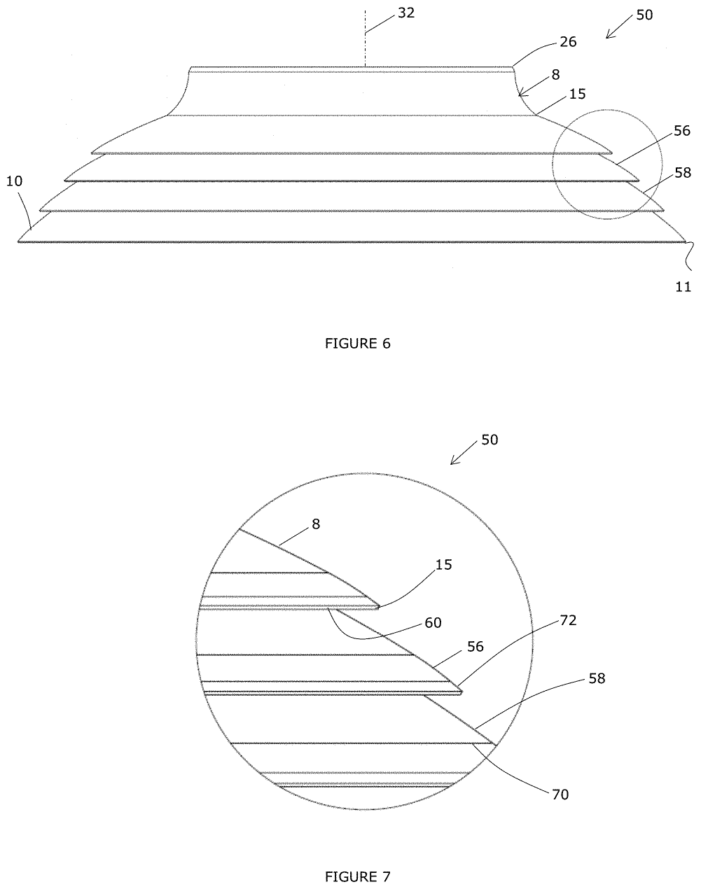

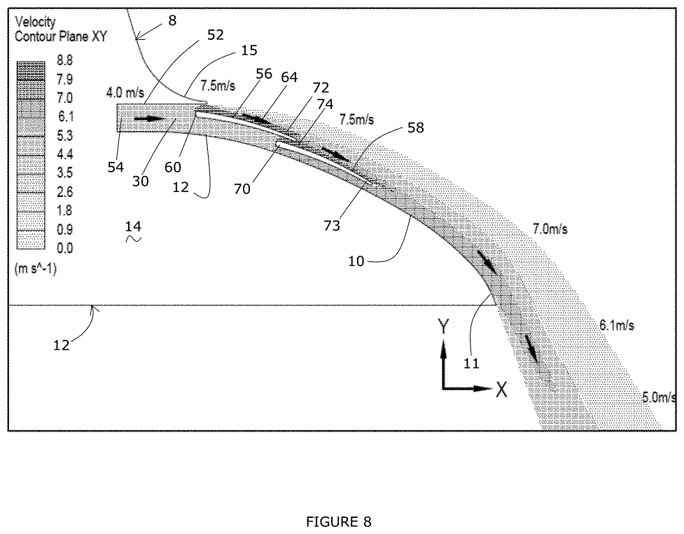

FIGS. 5 to 8 show a modified housing 50 which can be used to replace the housing 6 in the embodiment shown in FIGS. 1 to 4. In this embodiment, the same reference numerals will be used to denote parts which are the same as or correspond to those of the embodiment shown in FIGS. 1 to 4. The housing 50 includes an upper housing portion 8 which is somewhat truncated compared to the arrangement of the embodiment shown in FIGS. 1 to 4. Its upper rim 26 is circular as best seen in FIG. 5. In this embodiment, the base wall 12 is again domed and extends across the lower rim 15 of the upper housing portion 8 and its outer peripheral region forms the Coanda surface 10, as in the previous embodiment. The housing includes an inwardly directed flange 52 which defines an annular outlet passageway 54 leading to the outlet 30 of the chamber 14. The housing 50 includes first and second annular vane elements 56 and 58 which are located adjacent to the Coanda surface 10, as best seen in FIGS. 5 and 8. The vane element 56 has a leading edge 60 which is located in or adjacent to the outlet 30 of the housing 50. As best seen in FIG. 8, the leading edge 60 of the vane element 56 is located radially inwardly of the lower rim 15 of the housing portion 8 by a distance of about 3 to 20 mm and preferably about 10 mm (as measured tangentially relative to the outer surfaces of the vane element 56). Air from the chamber 14 passes through the outlet 30 and passes above and below the vane element 56 and its upper convex surface constitutes a second Coanda surface 64. The second vane element 58 includes a leading edge 70 and trailing edge 73. The leading edge 70 is located upstream of the trailing edge 72 of the vane element 56 and approximately midway between the trailing edge 72 and the Coanda surface 10, as shown in FIG. 8 (as measured in a perpendicular direction relative to the vane elements 56 and 58 and adjacent to the leading edge 70). The upper convex surface of the vane element 58 constitutes a third Coanda surface 74.

The leading edge 70 of the second vane element 58 is located upstream of the trailing edge 72 of the first vane element 56 by a distance of about 3 to 20 mm and preferably about 10 mm (as measured tangentially relative to the outer surface of the vane element 58).

The housing 50 shown in FIGS. 5 to 8 includes mounting elements or posts, ribs or the like (not shown) which interconnect the various parts. Typically, the upper housing portion 8 would be supported by the bracket 22 and the base wall 12 and vane elements 56 and 58 are supported from it. It will be appreciated that the upper housing portion 8, vane elements 56, 58 and base wall 12 are all stationary. The vane elements 56 and 58 can be considered to have leading and trailing edges relative to the air streams which flow about the vane elements.

It has been found from computer simulations of the housing 50 shown in FIGS. 5 to 8 that substantially increased airflows can be achieved by the use of multiple Coanda surfaces. For instance, with an airflow of about 4 msec in the outlet 30 an airflow of about 7.5 m/sec is predicted between the rim 15 and the leading edge 60 of the vane element 56. A similar airflow velocity is predicted above the leading edge 70 of the second vane element 58. The airflow decreases to about 7 m/sec at the lower rim 11 of the Coanda surface 10. The simulations also predict increased airflows caused by the compound Coanda surfaces because of increased volumes of air entrained over the outer surface of the upper housing portion 8, the vane elements 56 and 58 and Coanda surface 10 and entrained into the streams of air passing through the outlet 30. This substantially improves the overall efficiency of the fan.

The dimensions of the vane elements 56 and 58 can be chosen so as to optimise airflow. In one embodiment, the leading edge 60 of the vane element 56 is located approximately 5 mm upstream of the rim 15. The gap between the rim 15 and the leading edge 60 of the vane element 56 is about 2 to 20 mm and preferably about 10 mm (as measured perpendicularly relative to the outer surface of the vane element 56). Similarly, the gap between the leading edge 70 of the second vane element 58 is located beneath the trailing edge 72 of the first vane element by a distance of about 2 to 20 mm and preferably about 10 mm (as measured perpendicularly relative to the upper surface of the second vane element, adjacent to its leading edge 70). The length of the vane elements 56 and 58 (as measured in tangentially) can be varied in accordance with the overall size of the fanlight.

In the arrangement illustrated in FIGS. 5 to 8 there are two additional vane elements effectively producing three Coanda surfaces. It is thought that additional vane elements could be incorporated into the fan/light in order to further increase volumes of entrained air. However, additional vane elements could lead to manufacturing complexities and also have undesirable aesthetic effects on the overall appearance of the fan/light.

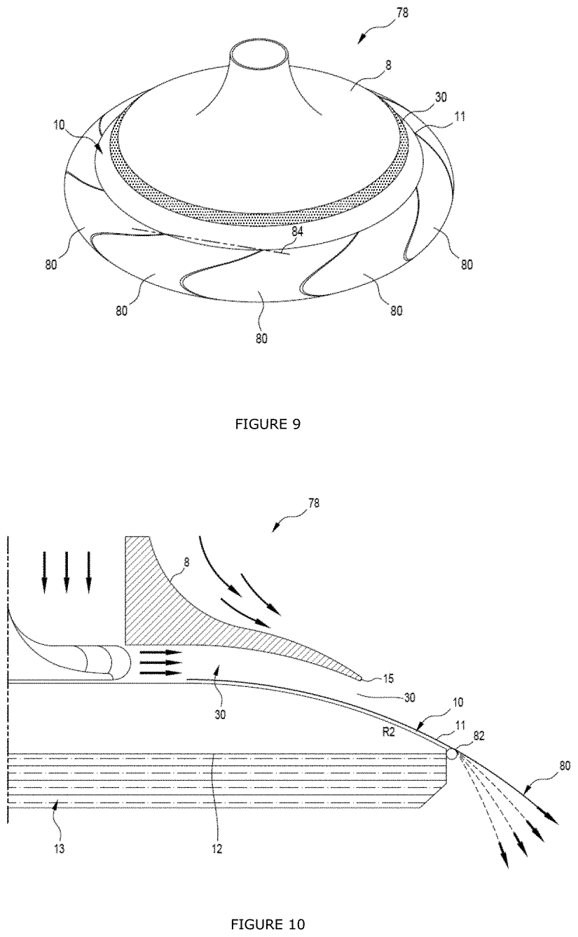

FIGS. 9 and 10 schematically show a modified fan/light 78. The same reference numerals have been used to denote parts which are the same as or correspond to those of the earlier embodiment. In this arrangement, a plurality of adjustable vanes 80 are mounted on or adjacent to the lower rim 11 of the Coanda surface 10. The vanes 80 overlap one another so that they can be adjusted in orientation whilst still maintaining a generally continuous surface; that is to say without substantial gaps. It would, of course, be possible to provide the vanes in a multiple Coanda surface arrangement similar to that shown in FIGS. 5 to 8. In use, the vanes 80 are adjustable in orientation relative to the Coanda surface 10 so as to vary the angle of the air stream which leaves the Coanda surface 10. The vanes 80 are connected by means of pivotal connections 82 which enable the adjustable vanes to pivot about axes 84 which are all perpendicular to the impeller axis 32 and generally tangential to the lower rim 11 of the Coanda surface 10. Only one of the axes 84 is shown in FIG. 9 for clarity of illustration. The vanes can be coupled to a linkage system (not shown) which can be operated by a servo-motor (not shown) in order to adjust their orientation. It is envisaged that this would be an option available to a user from a control unit (not shown) or a remote controller in order to vary the airflow distribution in a room.

### Additional Embodiments

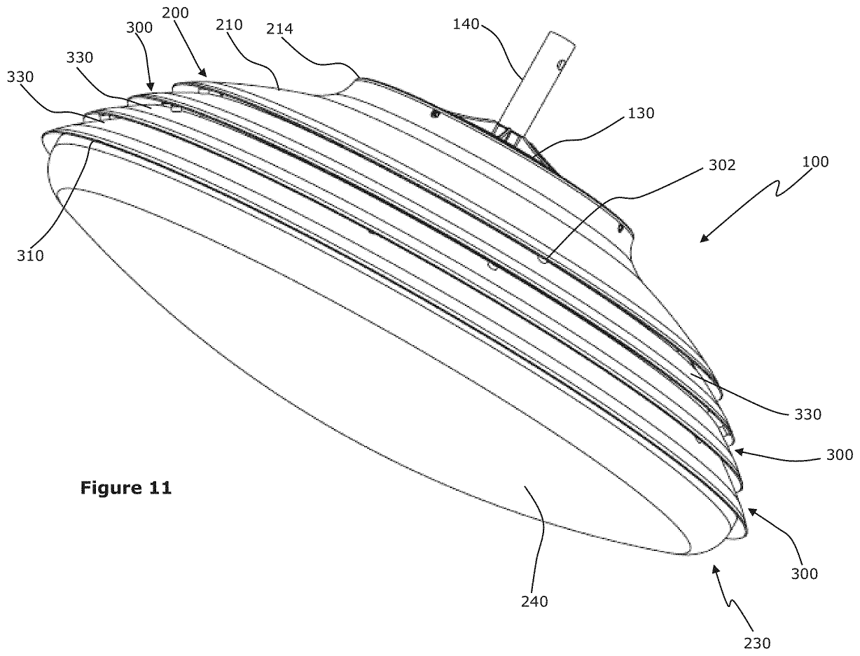

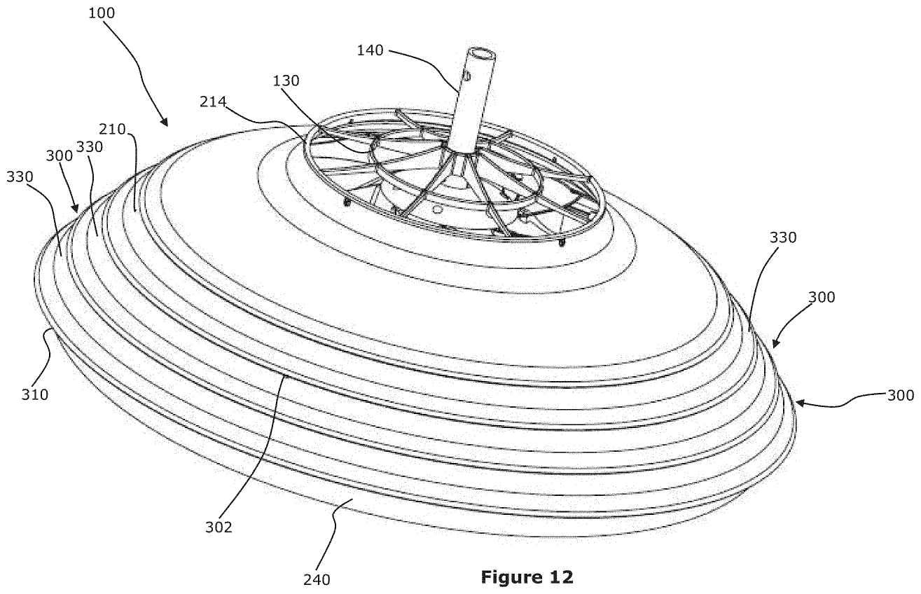

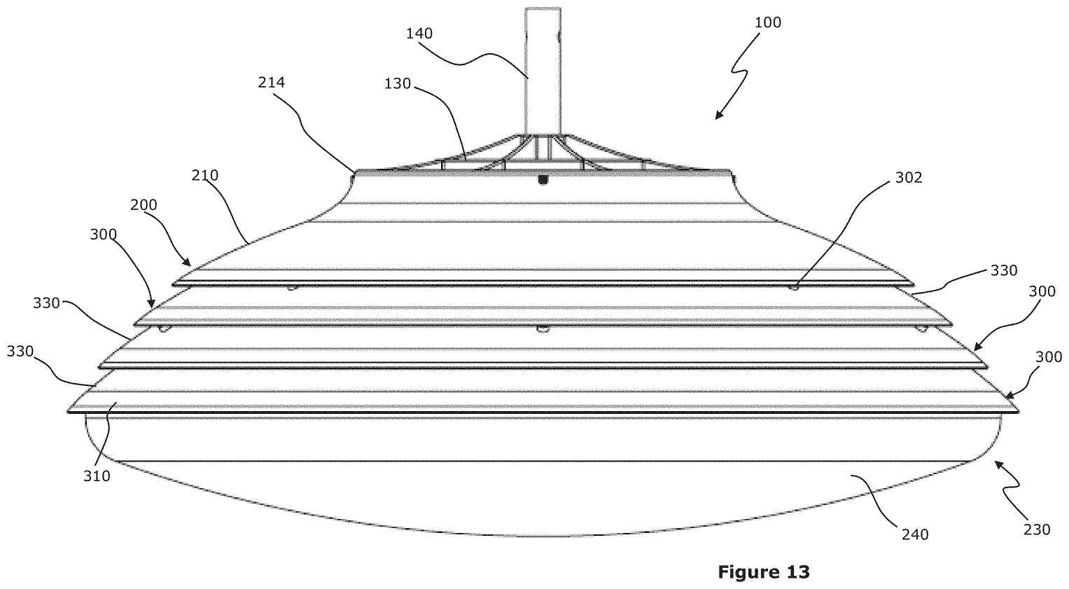

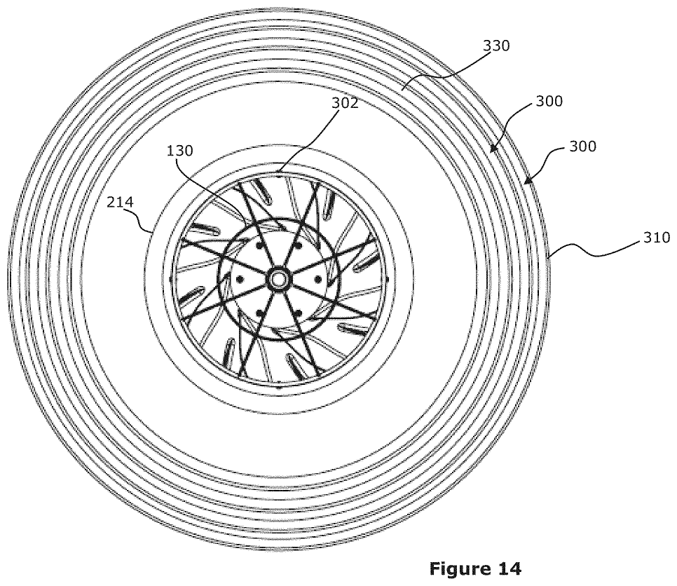

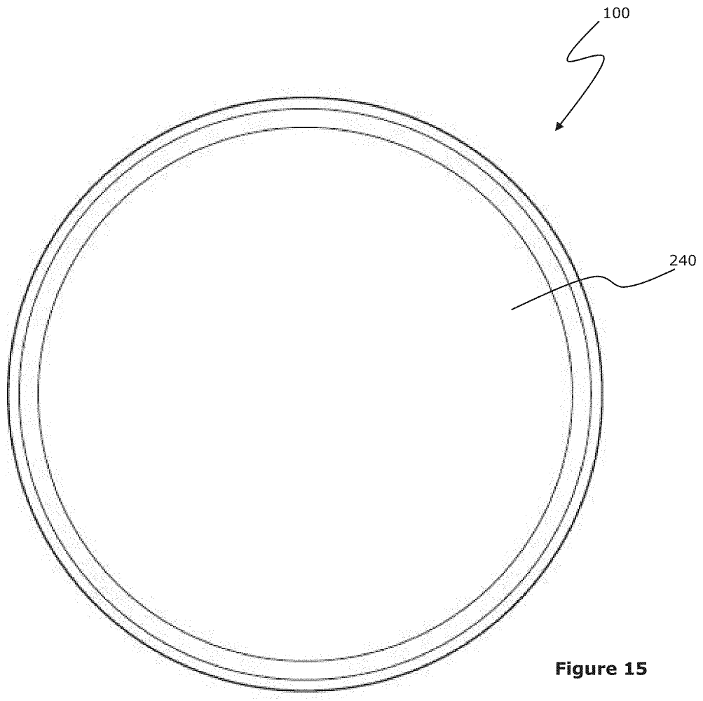

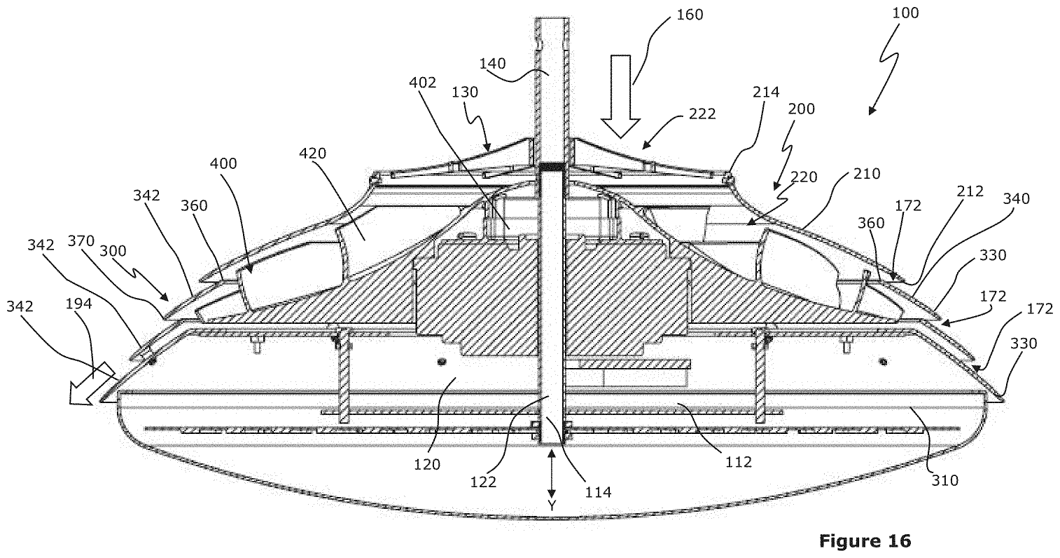

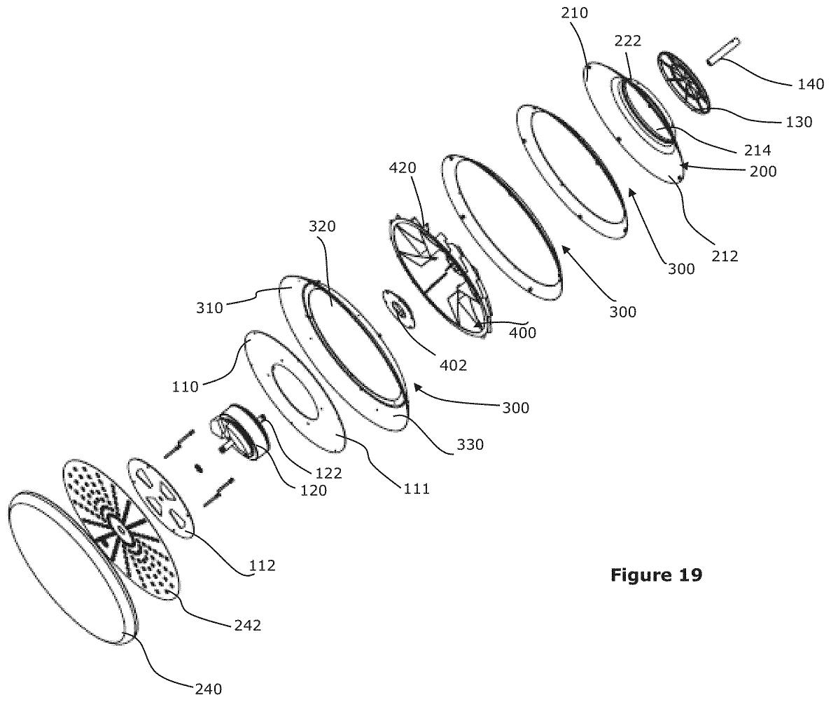

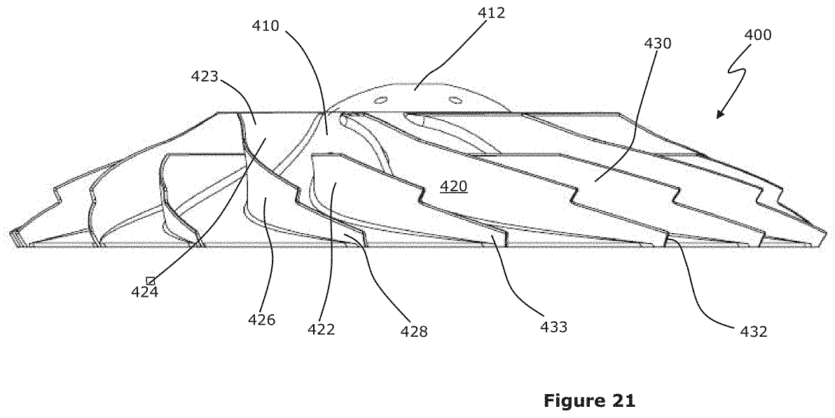

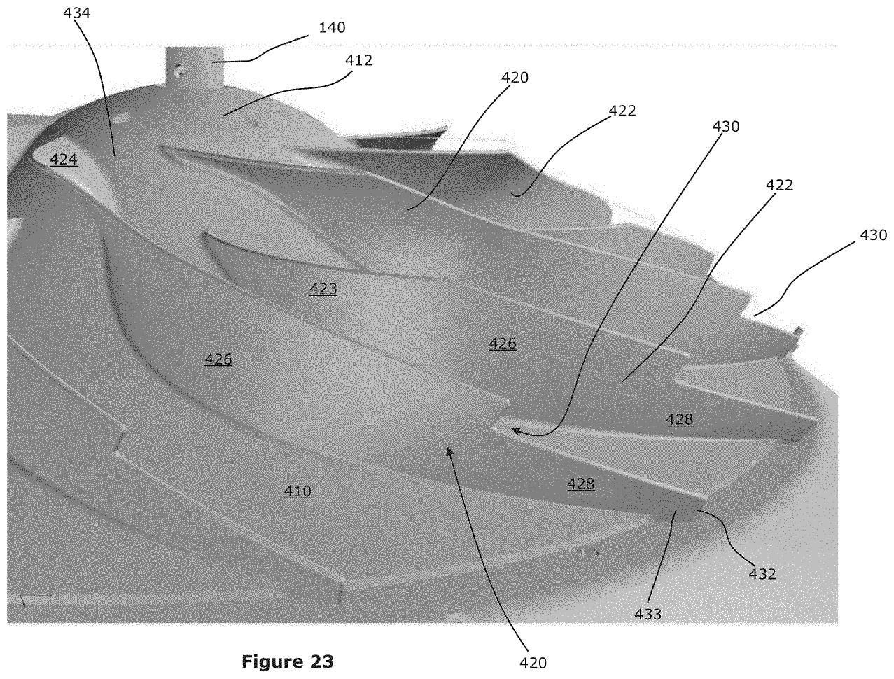

FIGS. 11 to 26 schematically illustrate a fan assembly 100 constructed in accordance with further embodiments of the invention. The fan assembly 100 is suitable for use with decorative light mountings and/or an airflow device. In the illustrated arrangement, the fan assembly 100 is adapted for mounting on a ceiling for projecting airflow in generally downward and outward directions. In one configuration, the fan assembly 100 is suitable as a speed-adjustable ceiling fan for generating high air volume flow at high blade rotation speeds. The fan assembly 100 comprises an outer housing 200, which includes an annular upper housing portion 210 and the outer housing 200 being louvred with a plurality of annular airflow-directing frames in the form of concentric vanes 300 mounted to the housing 200. Each vane 300 is configured with a lower rim 310 and an upper rim 320 of different diameters so that a sloped blade-like annular frame 330 is defined therebetween. In one configuration, the vanes 300 are coaxially mounted relative to each other and to the upper housing portion 210 in a vertically overlapping manner so as to define airflow passageways 168 and outlets 170. In the preferred embodiment, the outer housing 200 is louvred with three such vanes 300 vertically connected relative to each other in an overlapped manner. In an alternative embodiment, the outer housing 200 is louvred with two such vanes 300 vertically connected relative to each other in an overlapped manner. In yet another alternative embodiment, only one vane 300 is provided and mounted to the outer housing 200. While the outer housing 200, upper housing 210 and vane(s) 300 of the fan assembly 100 have been described to be provided with annular configurations, it is to be understood that these features of the present invention are not limited to such circular shapes and that rectangular, ovular, square, pentagonal, hexagonal, octagonal and other non-circular shapes may also be used for the fan assembly 100, the outer housing 200, the vane(s) 300, impeller 400 and any other parts of the fan assembly 100. In the preferred embodiment, a rotating impeller 400, in the form of a centrifugal impeller, is mounted internally within the outer housing 200 for generating streams of outflow air between the vanes 300 and an electric motor 120 is compactly seated within the impeller 400, which acts as a housing for the motor 120. It is intended that streams of outflow air through the louvred sections (vanes 300) of the outer housing 200 are a combination of internal and external air flows, wherein the latter involves entraining surrounding air along the outer housing 200 together with serial Coanda air flow effects to improve airflow volume and velocity, as will be explained in detail below.

Light cover and fitting(s) 240, 242 of any suitable shape and configuration may be installed on a lower portion 230 of the fan assembly 100. In one example, a mounting plate 110 is affixed to the lowest-positioned vane 300 for mounting, for example, motor mounting bracket 112, LED light fittings 242 and light fitting cover 240. In some embodiments, the light fitting cover 240 is in the form of a dome which generally encloses the lower portion 230 of the fan assembly 100 so as to conceal components of the fan from view when in use and to provide a visually attractive appearance. The light fittings 242 can include an array of LED's with associated driving circuitry, fluorescent lamps or other light emitting elements, and would typically include a translucent diffuser (not shown) so as to give the fan assembly 100 an attractive appearance. Details of the light fitting do not need to be described in detail as they can be the same as those commonly used in the art. It is preferred that the outer periphery of the light cover and/or fitting(s) 240, 242 does/do not extend beyond a lower rim 310 of the lowest-positioned vane 300 so as to not have any influence on air flowing over the vanes 300, as will be explained in more detail below.

The upper housing portion 210 and the one or more vane(s) 300 of the outer housing 200 define an internal chamber 220 within which is located the impeller 400 and the electric motor 120. The impeller 400 is mounted on an impeller shaft 122, which is coaxially mounted to and driven by the electric motor 120. In one embodiment, the impeller 400 is a centrifugal impeller. In other embodiments, the impeller 400 may be of any suitable impeller with impeller blades 420 configured to draw ambient air and generate air streams in a generally outward direction. In the preferred embodiment, the impeller 400 is configured to generate air streams in a radially outward direction that is generally, perpendicular to a vertical axis, in use. In one embodiment, the impeller 400 is axially mounted to the impeller shaft 122 and the motor 120 by way of an impeller mount 402 located between the impeller 400 and the motor 120. In some configurations, the impeller 400 is mounted above the motor 120 with the motor 120 nestled within a hub of the impeller 400 (which will be discussed in detail in a later section), while in other configurations, the impeller 400 is mounted below the motor 120. It is preferred that the impeller shaft 122 is hollow so that it can carry electrical conductors (not shown) for the light fitting(s) 242. The fan assembly 100 includes a down rod 140, which is fastened to a ceiling bracket (not shown) at one end and coupled to the impeller shaft 122 at the other end. The fan assembly 100 is also provided with motor mounting brackets 112 which in use secure the motor 120 to the outer housing 200 and/or vanes 300. Details of the preferred impeller design will be described in a separate section below. Mounting the motor 120, impeller 400 and the housing 200 along the same vertical impeller shaft 122 improves the ease of assembly during manufacturing and improves stability of the fan during operation.

In the illustrated arrangement, an upper rim 214 of the upper housing portion 210 has an opening 222 defining an airflow inlet 224 to the internal chamber 220. The opening 222 is configured to receive a vent 130 in the form of a shroud shaped with sweeping curved airflow passageways to direct and/or draw inlet airflow 170 to an inlet of the impeller 400 which is located beneath the vent 130 when in use so as to reduce turbulent airflow at the inlet 224, which in turn improves volume of inlet airflow and performance of the impeller 400. Moreover, the vent 130 can be configured so as to minimise any gaps between the vent 130 and blades of the impeller for the purpose of reducing pressure loss (air leakage) around entrance to the impeller 400 as well as any noise caused by the leakage while improving performance and efficiency of the impeller 400 at lower RPM ranges. In one configuration, the vent 130 is adapted to direct air to flow through openings located closer to an outer edge of the vent 130. It is to be understood that while inlet 224 is the primary airflow inlet for the fan assembly 100, it is possible that air will also be drawn from other openings that are exposed to an airflow path to the impeller 400. In some configurations, the vent 130 is not provided at the opening 222 for drawing inlet airflow 170.

The louvred vanes 300 of the outer housing 200 define one or more annular outlet passageway(s) 168 leading to airflow outlet 170 from the internal chamber 220. The outlet passageway 168 is defined by an annular gap 172 formed between adjacent vanes 300 or between the upper housing portion 210 and an adjacently mounted vane 300. For example, the annular gap can be defined between a lower rim 212 of the upper housing portion 210 and an upper surface 340 of the sloped blade 330 of a vane 300 that is mounted immediately adjacent the upper housing portion 210. In the preferred embodiment, additional annular outlet passageways 168 and outlets 171) are provided by annular gaps 172 formed between a lower rim 310 of the adjacently-mounted vane 300 and an upper surface 330 of a successive vane 300 and so on. Each annular gap 172 formed between successive sets of adjacent vanes 300 provides an additional airflow outlet 170. The upper housing portion 210 can be spaced apart and coupled to the sloped blade 330 of the adjacent vane 300 by means of fixed-length spacer projections or sleeves 302 so as to maintain a constant outlet gap 172 therebetween. Similar spacer projections or sleeves 302 can be used to maintain a constant outlet gap 172 between adjacent vanes 300. In some configurations, the sleeves 302 are formed on the underside of the housing 200 and/or vanes 300.

It is preferable that the gap 172 between the upper housing portion 210 and the sloped blade 330 of the vanes is evenly spaced and has a uniform height of about 20 mm or less. In the preferred embodiment, the height of the gap 172 is about 15 mm, and more preferably about 10 mm. In other embodiments, the height of the gap 172 is about 5 mm. In some configurations, the positioning of the vanes 300 and/or the upper housing portion 210 and its adjacent vane 300 is configured such that annular gaps 172 of different heights are used. For example, the fan assembly 100 may have an outer housing 200 configured with three sets of annular gaps 172 having gap heights of about 11 mm, 9 mm and 7 mm, respectively. In other configurations, the fan assembly 100 may have an outer housing 200 that is configured with two sets of annular gaps 172 having gap heights of about 15 mm and 10 mm, respectively. It is to be understood that while the airflow outlet(s) 170 have been described to be annular in the preferred embodiment, non-annular and linear outlets may also be used if desired.

In the preferred embodiment, the fan assembly 100 is provided with a plurality of vanes 300 of increasing diameters and each vane 300 being coupled in a vertically overlapping manner to an upper surface 340 of the sloped blade 330 of a lower, successive, vane 300. In one embodiment, the fan assembly 100 is provided with two vanes 300, while in other embodiments the fan assembly 100 is provided with three or more vanes 300. In some configurations, the outlet gap 172 between vanes 300 differs in height when compared with the outlet gap 172 defined between the upper housing portion 210 and the adjacently mounted vane 300. In the preferred embodiment, the upper rim 320 of each vane 300 has a smaller diameter than the lower rim 310 of each vane, which allows the sloped blade 330 to have a generally upward-facing upper surface 340 and a generally downward-facing lower surface 350, when mounted to a ceiling in use. The upper surface 340 forms part of an outer surface of the vanes 330. In some configurations, the sloped blades 330 may have a width in the radial direction of about 40 mm, and preferably a minimum width of about 40 mm, though the sloped blade 330 may have any desired width. The vanes 300 are configured to be about 2 mm thick or of any suitable thickness so as to allow the vanes 300 to be readily mounted to the upper housing portion 210 and mounted to successive vanes 300 of greater diameters in a vertically overlapping manner while allowing for the formation of outlet gaps 172.

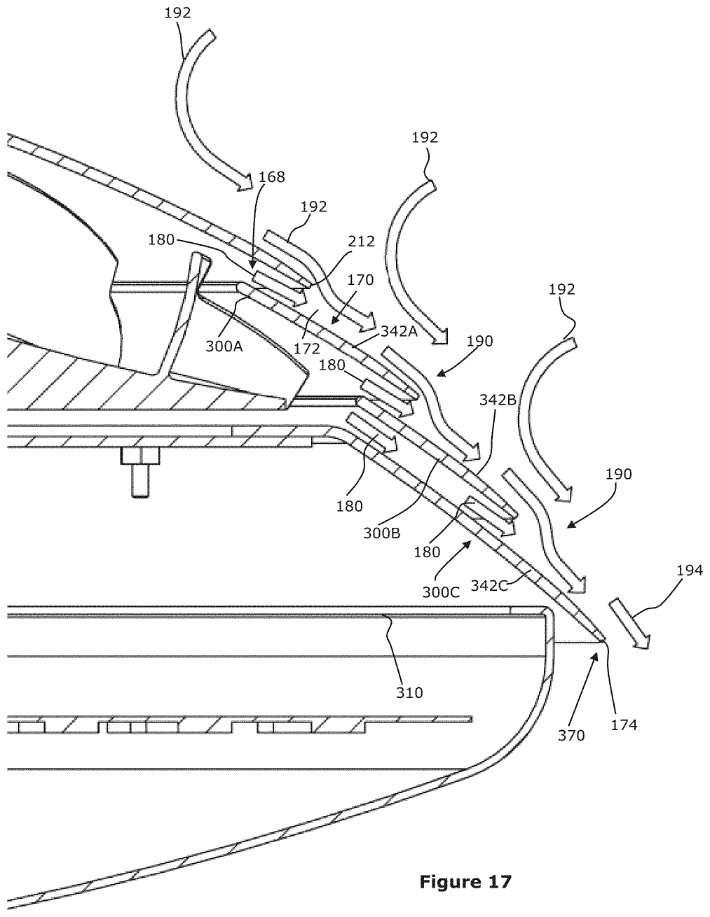

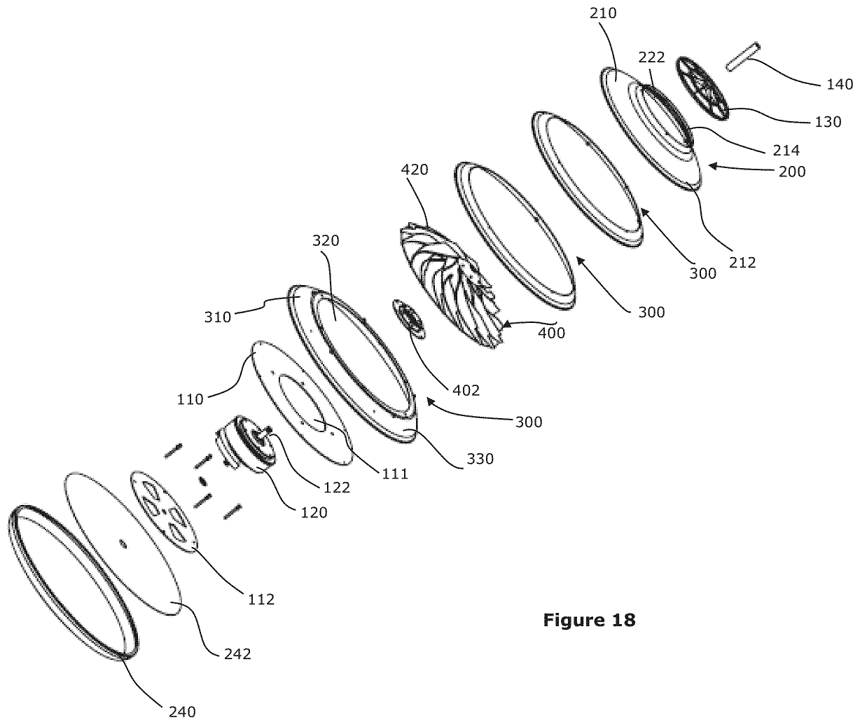

In one embodiment, as shown in FIGS. 17 and 18, the overlapping portions between adjacent louvred vanes 300 (and/or an overlapping portion between the upper housing portion 210 and its adjacent louvred vane 300), which define the outlet passageway 168 are substantially parallel relative to each other. In another embodiment, the overlapping portions, and hence the outlet passageway 168, are divergent from an inlet end to an outlet end, which means that the gap height at the outlet end is larger than the gap height at the inlet end, so as to provide favourable airflow pressure and velocity profiles at the outlet 170.

Each sloped blade 330 has a leading edge 360 which is located in or adjacent to an entrance of the annular outlet passageway 168 and a trailing edge 370 which is located at an end of the vane 300 opposing the leading edge 360. As best seen in FIG. 17, the leading edge 360 of each vane 300 is located radially inwardly of a lower rim 212 of the housing portion 210 or the lower rim 310 of the vane 300 by a distance of about 2 to 20 mm and preferably about 10 mm (as measured tangentially relative to the outer surfaces of the vane 300). Air stream from the chamber 220 flows through the annular outlet passageway 168, through the outlet 170 and passes over the upper surface 340 of the sloped blade 330 from the leading edge 360 to the trailing edge 370.

The outlet gap 172 defined between the upper housing portion 210 and the adjacent vane 300 as well as any outlet gap(s) 172 defined between said adjacent vane and any successive vanes 300 direct exit airflow from within the internal chamber 220 to the air outlet(s) 170. In an arrangement with a plurality of vanes 300 having comparable sized outlet gaps 172, the upper surface 340 of the lowest-mounted vane 300 of the fan assembly 100 will have the greatest airflow and therefore serve as a primary air outlet 174 of the fan assembly 100 in use. As will be described in detail below, the upper surface 340 and lower surface 350 of each vane 300 serve important functions in dictating the flow characteristics of air streams from the impeller 400 to the ambient. In the preferred embodiment, the upper surface 340 of each vane 300 is configured with a Coanda surface 342 so as to create a low pressure area at an air inlet immediately preceding the upper surface 340 during use to entrain ambient air into a stream of outlet air, thereby amplifying the magnitude of airflow at the outlet 170 (the Coanda effect).

Each Coanda surface 342 of the vanes 300 is configured so as to operate to direct air towards a successive one of said Coanda surfaces 342 of respective vanes 300. For example, with reference to FIG. 18, airflow leaving the Coanda surface 342A of a first vane 300A is drawn to the Coanda surface 342B of a second vane 300B and additional ambient air 192 is entrained into the subsequent output airflow 190. It has thus been found that increased airflow can be achieved by using multiple Coanda surfaces effectively operating in series. In the preferred embodiment, the output airflow 190 leaving the second vane 300B is drawn to a further Coanda surface 342C of a third vane 300C which further increases the volume of ambient air 192 entrained by the exit airflow and velocity of the resultant airflow 190. Each gap 172 formed between the respective vanes 300A, 300B, 300C further increases the pressure drop of the exit airflow and enhances the drawing of ambient air into the resultant airflow. The use of multiple Coanda surfaces in this way significantly increases airflow volumes at the primary air outlet 174 (the primary outflow air 194), thereby improving the airflow volume and velocity profiles of the fan assembly 100.

In one embodiment, the entire upper surface 340 of the sloped blade 330 constitutes the Coanda surface 342. The Coanda surface 342 is convex and configured with a radius of the convex curvature of between about 300 mm and 400 mm. The convex curvature of the Coanda surface 342 helps guide airflow moving over the Coanda surface 342 towards a subsequent, lower, Coanda surface 342 in a series. Coanda surfaces 342 in the preferred embodiment are vertically arranged relative to each other and extend downwardly with an angle of less than 90° relative to a vertical axis. Preferably, the downward extending angle of the Coanda surface 342 is between about 20° and about 40°, more preferably between about 24° and 38°, including about 31° and 36°. In some configurations, the downward extending angle of a subsequent downstream Coanda surface 342 has a different downward extend angle than that of the preceding (upstream) Coanda surface 342. In the preferred embodiment, all the Coanda surfaces 342 in the series of vertically arranged vanes 300 have a convex curvature. In some configurations, the vanes, and hence Coanda surfaces 342, are positioned relatively offset to each other and arranged to be partially overlap when seen from a plan view. This arrangement improves the flow of the air stream from one Coanda surface 342 to the next in series. In one configuration, the upper surface 340 of the sloped blade 330 and hence the Coanda surface 342 of one or more vanes 300 is shaped with aerofoil contours to enhance the Coanda effect by reducing air resistance and increasing the entrainment of ambient air 192 into the outlet airflow 190. The Coanda surface 342 may also be said to be cambered about its mid-axis. In some configurations, the vanes 300 are provided with rounded leading edges 360 and tapering trailing edges 370 to enhance aerodynamic flow characteristics.

The Coanda effect may also be achieved with one or more upper surfaces of each vane 300 being configured with flat Coanda surfaces 342, though the angle of the exit airflow from each flat Coanda surface 342 may differ from vanes in which the Coanda surfaces 342 are convex to assist with entrainment of ambient air 192 and with directing the flow of air stream from one Coanda surface 342 to another in the series. In an alternative embodiment, all the Coanda surfaces 342 are flat. This configuration reduces manufacturing complexity and cost.

The vanes 300 are arranged so that they are located, in use, in the path of the exit stream of air from the impeller 400. The lower surfaces 350 of each vane 300 function as deflectors positioned downstream of the impeller 400 to divide the exit air stream into one or more separate streams of air, each routed through a respective outlet passageway 168 and gap 172 formed between adjacent vanes 300 or the upper housing portion 210 and its adjacent vane 300. With reference to FIG. 18, the separated streams of air 180 are then directed by the lower surface 350 to pass through gaps 172 and over the respective Coanda surface 342. The separated streams of air 180 augment the serial Coanda airflow stream 190 (as described above) to further enhance the flow rate and volume characteristics of the resultant airflow output 194 through the primary air outlet 174 from the fan assembly 100.

The dimensions of the vanes 300 can be chosen so as to optimise airflow. The length of the vanes 300 (as measured in tangentially) can be varied in accordance with the overall size of the fan assembly 100. In the embodiment as shown in FIGS. 11 to 20, three additional vanes 300 are mounted to the upper housing portion 210 to effectively produce three Coanda surfaces 342. It is thought that additional vanes 300 could be incorporated into the fan assembly 100 in order to further increase volumes of entrained air. However, additional vanes 300 could lead to manufacturing complexities and also have undesirable aesthetic effects on the overall appearance of the fan assembly 100.

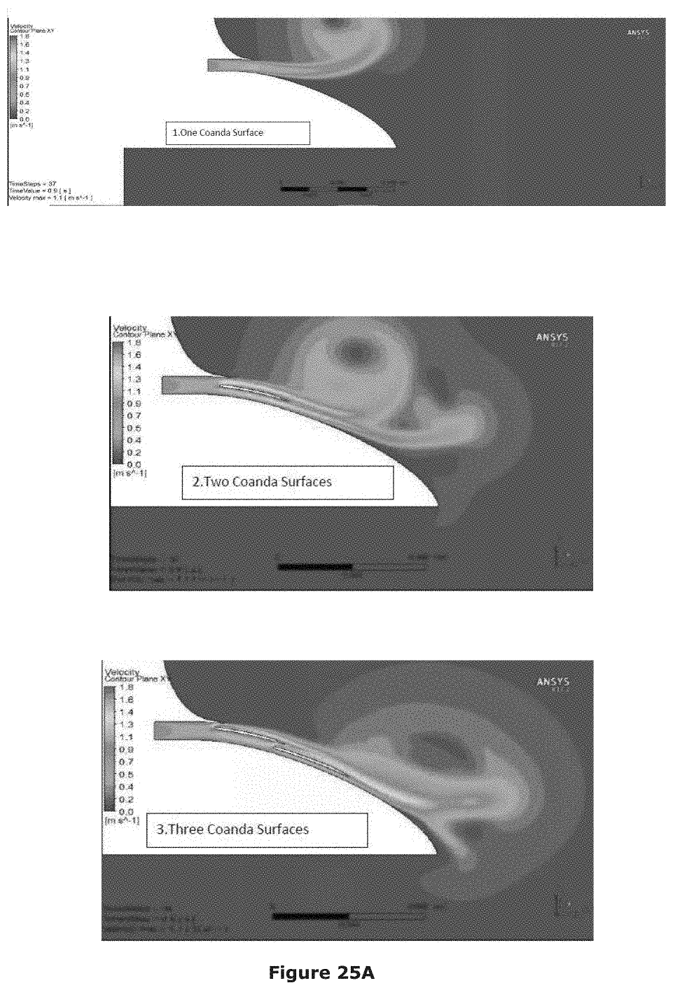

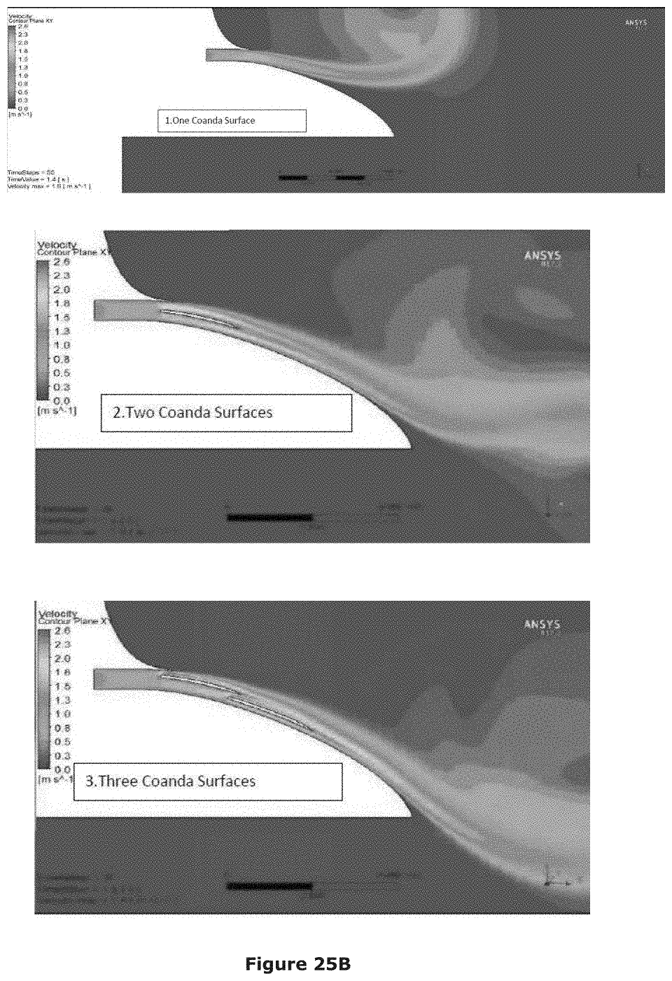

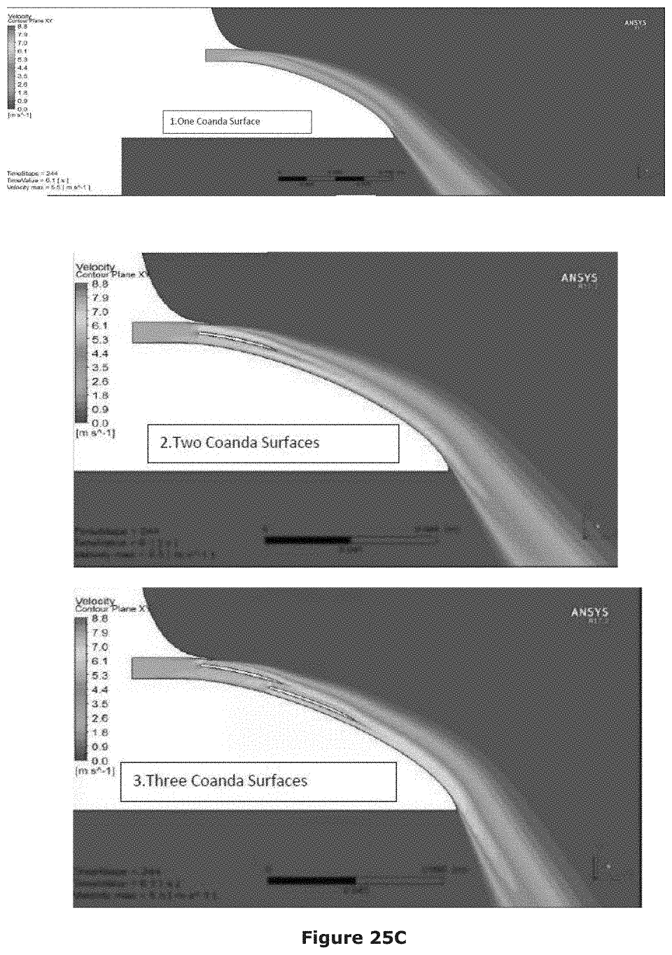

The synergistic effect of 1) multiple Coanda surfaces 342 of the upper surfaces 340 working in a series to entrain ambient air 192, and 2) supplementing said Coanda airflows 190 with additional streams of airflow 180 from the impeller 400 substantially improves the overall performance of the fan assembly 100. With reference to FIG. 17 for instance, resultant airflow velocity of about 6.4 m/sec has been achieved at the primary air outlet 174 of a third vane 300C with an impeller of 400 mm in diameter operating at about 620 revolutions per minute. This airflow velocity is significantly higher than that of a stream of air leaving an outlet 170 of the first vane 300A. Referring to FIGS. 25A to 25C, which relates to time-based sectional flow profile comparisons of initial to tertiary air flow phases of fan assemblies embodying the invention having one, two and three Coanda surfaces, it can be seen that having multiple Coanda surfaces working in series improved the volume of surrounding air entrained by the fan assembly as well as airflow velocity of the fan assembly at the primary outlet airflow. The Coanda surfaces also serve to direct the exit airflow in a substantially downward and outward direction to a user below.

In the illustrated arrangement, the upper housing portion 210 is formed as a surface of revolution about the axis Y, although this is not essential. It is also preferred, that the inner and outer surfaces of the housing 200 are aerodynamically shaped so as to enhance production of generally laminar flow to the outlets 170 and the primary air outlet 174. The curved configuration of the upper and lower surfaces 340, 350 of the sloped blades 330 of the vanes 300 provide smooth airflow pathways and also enhances laminar flow to the outlets 170, 174. In one configuration, an internal leading edge of the sloped blades 330 is configured with an annular shape and centred so that the impeller 400 can rotate within its required tolerances. In one embodiment, the housing 200 and the vanes 300 are configured such that an outlet passage downstream of the impeller 400, defined between the inner surface of the upper housing portion 210 and the upper surface 340 of the respective vane 300, tapers gradually towards the opening 170. This increases airflow velocity and again promotes laminar flow.

In some embodiments, the housing 200 may include mounting elements or posts, ribs or the like (not shown) which interconnect the various parts. Typically the upper housing portion 210 would be supported by the stationary down rod 140 and ceiling mounting brackets, and the one or more vanes 300 are supported from it. It will be appreciated that the upper housing portion 210, the one or more vanes 300 and any light fitting are all stationary.

In a further embodiment, a plurality of adjustable vanes 300 are instead mounted on or adjacent to the lower rim 212 of upper housing portion 210. The adjustable vanes 300 overlap one another so that they can be adjusted in orientation whilst still maintaining sufficient outlet gaps 172 allowing outflow of air. It would, of course, be possible to provide the vanes in a multiple Coanda surface arrangement similar to that shown in FIGS. 11 to 20. In use, the vanes 300 are adjustable in orientation relative to the Coanda surface(s) 342 so as to vary the angle of the air stream which leaves the Coanda surface 342. In one configuration, the adjustable vanes 300 are connected by means of pivotal connections which enable the adjustable vanes 300 to pivot about axes perpendicular to the impeller axis Y and generally tangential to the lower rim 310 of the vanes 300. The vanes 300 can be coupled to a linkage system (not shown) which can be operated by a servo-motor (not shown) in order to adjust their orientation. It is envisaged that this would be an option available to a user from a control unit (not shown) or a remote controller in order to vary the airflow distribution in a room.

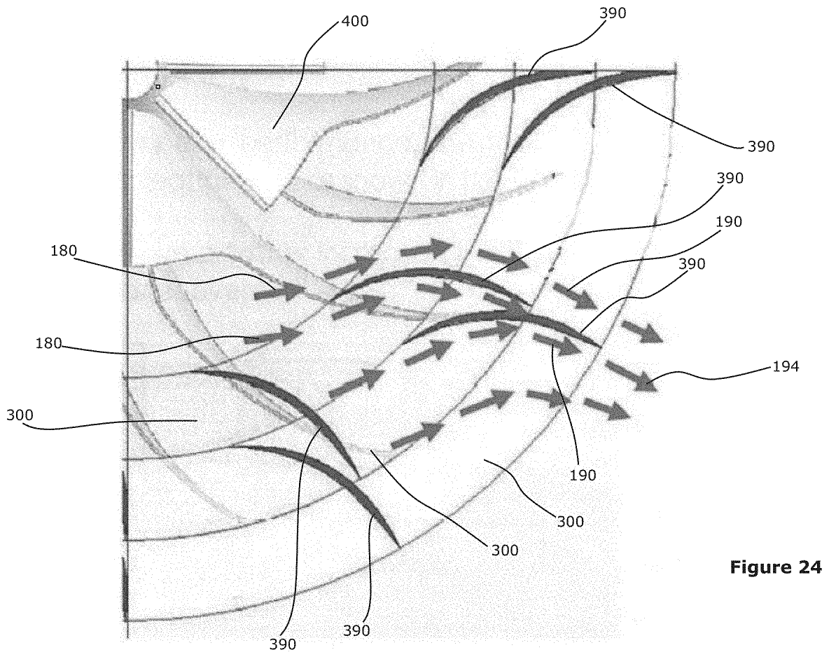

With reference to FIG. 24, in an alternative embodiment, guides in the form of arcuate deflectors 390 which are provided circumferentially between the annular outlet passageways 168 and/or outlet gaps 172 on the sloped blade 330 of the vanes 300 to direct and guide the outlet airflow 180, 190 to flow in an outward direction. In one configuration, the outward direction is at a radial angle of 90° with respect to a tangent of an outer edge of the sloped surface 340 or the Coanda surface 342. In the illustrated embodiment, the arcuate deflectors 390 span across two adjacent vanes 300. It is to be understood that the deflectors 390 may occupy one vane 300 or spread across a plurality of vanes 300. The deflectors 390 as shown in FIG. 25 are arcuate as seen from a plan view, however linearly configured deflectors 390 may also be used if desired. The arcuate deflectors are attached to the underside of the vanes and span from leading edge to trailing edge of the same vane.

In FIG. 16, the basic operation of the fan assembly 100 is such that the motor 120 drives the impeller 400 so that it rotates about impeller axis Y. This causes air to be drawn into the inlet 130 and flow through outlets 170, 174. The internal surfaces of the internal chamber 220 and the shape of the gap 172 between the upper housing portion 210 and the upper surface 340 of the vanes 300 are such that the stream of air 180 passing through the outlets 170, 174 has laminar flow or substantially laminar flow. The stream of air 180 passing over the Coanda surface 342 experiences the Coanda effect so that it moves adjacent to the Coanda surface 342 and is discharged into the room below in a generally downward and outward direction or to a Coanda surface of a subsequent vane mounted in series. As described above, it has been found that significant improvement in performance can be obtained by providing multiple Coanda surfaces 342 which effectively operate in series so as to lead to significantly higher flow velocity and volume of ambient air Which is entrained into the air flowing from the housing 200. The parts which form the housing 200 and vanes 300 could be moulded from plastics material such as polystyrene or ABS. Alternatively, they could be formed from spun or pressed metal such as aluminium.

### Impeller Design

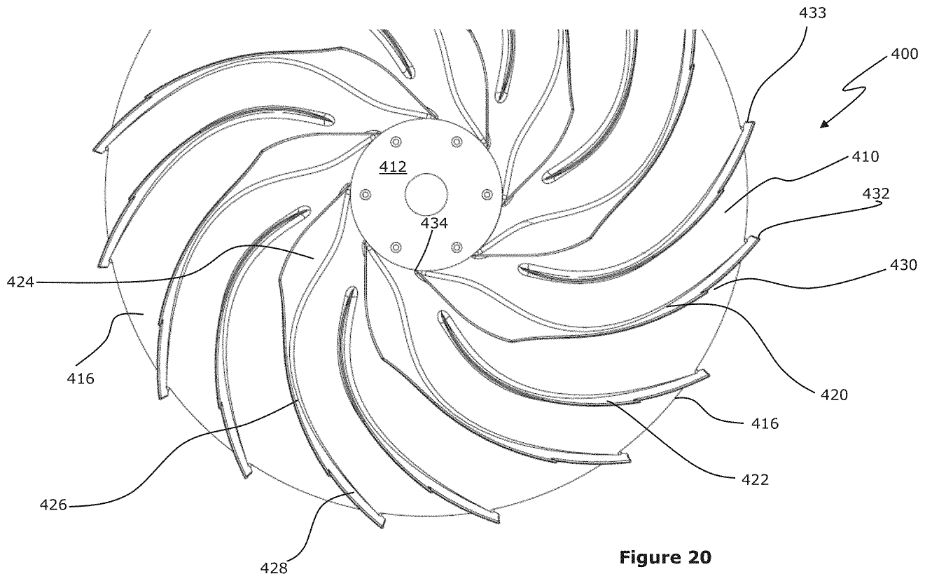

Impeller for use with a preferred embodiment of the invention will now be described with reference to FIGS. 20 to 23. While any suitable impeller which draws ambient air from an axial direction and generates air streams in an outward direction that is generally orthogonal to the axial direction may be used with the fan assembly 100 of the present invention, a centrifugal type impeller is used in the preferred embodiment. A centrifugal impeller can be defined as an impeller configured with an annular flow path that is substantially parallel to the axis of rotation at an inlet and substantially perpendicular to the axis of rotation at an outlet.

In the preferred embodiment, the impeller 400 comprises a rotatable impeller hub 410, which is mountable to the motor 120 by way of an impeller mount 402, to which the impeller hub 410 is fastened. The impeller hub 410 is of a general dome shape having a raised centre in the form of a hub dome 412 and the height of hub 410 transitions smoothly from its highest point at or about the hub dome 412 to its lowest point which is at the peripheral (circumferential) edge of the hub 410. In one configuration, the hub 410 is seated above the motor 120 when assembled and also acts as a housing for concealing the motor 120 however, it is also possible for the motor 120 to be mounted above the impeller 400 closer to a ceiling. The hub 410 is provided with a central opening 414 for receiving the down rob 140 or impeller shaft 122. In one configuration, the impeller hub has a diameter of about 400 mm, though it is to be appreciated that the impeller embodying the present invention can be configured according to any suitable dimension.

As can be seen in FIGS. 20 to 23, the impeller 400 comprises two sets of blades positioned upon the hub 410. A set of arcuate continuous blades 420 is evenly spaced on the hub 410, each continuous blade is positioned at a root end 434, which is located proximate the centre of the hub 410, and extends to a peripheral edge 416 of the hub 410. A set of arcuate splitter blades 422 is positioned between adjacent continuous blades 420; splitter blades 422 have shorter blade lengths and serve to reduce the gap (air channel) between adjacent continuous blades 420 so as to prevent excessive diffusion of air flow as the air channels increase in size with the increasing impeller hub circumference from the hub dome 412 to the periphery edge 416. In the preferred embodiment, the impeller blades 420, 422 are curved along their lengths (towards the left when viewed from the perspective of the blade root end 434) so as to be optimised for clockwise rotation. In other embodiments, the curvature of the impeller blades 420, 422 is optimised for anti-clockwise rotation. The height of the continuous blades 420 vary along the blade length starting with maximum blade height at the blade root end 434 and slopes to a lowest blade height at the blade tip end 432. The variance of blade height along its length allows the impeller blades 420, 422 to fit within the outer housing 200 and louvred vanes 300 of the fan assembly 100. A blade step 430 in the form of a kink in an upper portion of each blade 420, 422 is provided to accommodate the position of an adjacent louvred vane 300. This reduces any air channel gap formed between the blades 420, 422 and corresponding undersides of the upper housing 210 and/or louvred vanes 300 to improve air flow through outlet passageways 168 formed by the outer housing 200 and reduce turbulence. In one configuration, the blade step 430 has a forward leaning edge, in which the top edge of the step 430 has a greater radius than an inside edge the step 430. The angle of the top edge of the blade step can be configured to suit an angle of the outlet passageways 168 formed by the outer housing 200.

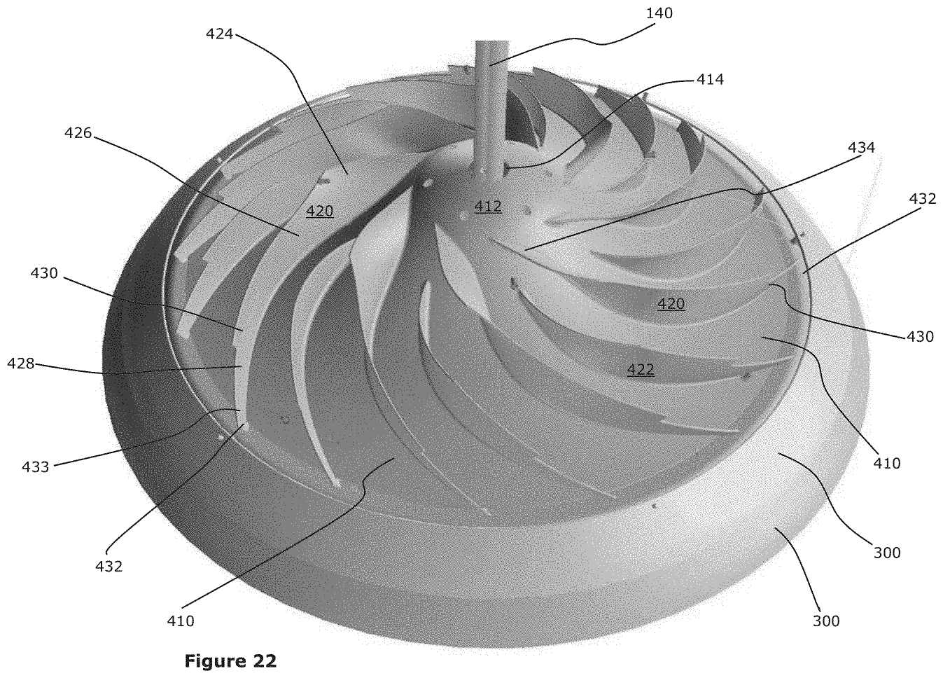

The impeller blades 420, 422 can be said to have a twisted profile along the blade length. The continuous blade 420 can be divided into three distinct sections, namely (1) a blade root portion 424, which refers generally to a portion of the blade 420 that is closest to the blade root end 434 (2) a blade mid portion, which refers generally to a mid-portion of the blade 420, and (3) a blade end portion, which refers generally to the portion of the blade that is close to the blade tip end 432. In one embodiment, as can be clearly seen in FIG. 22, the blade root portion 424 is configured with the greatest blade height and comprises a blade wall having a forward lean (leaning forward in the direction of clockwise rotation). The blade mid portion 426 extends continuously from the root portion 424 with reduced blade height and the blade wall transitions to a generally neutral lean (no leaning). The last third of the blade length, the blade end portion 428 extends continuously from the blade mid portion 426, with its blade height reducing, with increasing radial distance from the centre of the hub 410. In one configuration, the blade wall of the blade end portion 428 transitions from the neural lean of the blade mid portion 426 back to a forward lean.

The height and leaning characteristics of the mid portions 426 and end portions 428 of the splitter blades 422 are generally consistent with corresponding portions of the continuous blades 420, though the root portion 423 of the splitter blades are positioned further away from the impeller hub centre and configured with a blade wall that is lower than the walls of adjacent continuous blades 420 and substantially parallel relative to a horizontal plane. In one configuration, the tip end 432 of the impeller blades 420, 422 overhang (protrudes) from the periphery edge 416 of the impeller hub 410 for the purpose of improved fit with the housing 200. It is to be understood that profiles of the impeller blades 420, 422 are not limited to the examples described as the blade profiles should be configured to correspond with the shape and configurations of the annular outlet passageways 168 defined by the outer housing 200 and louvred vanes 300 so as to reduce any gaps formed therebetween, thereby reducing undesired turbulence effects.

In use, the impeller is configured to rotate in a clockwise manner and ambient air is drawn into an upper portion (centre) of the dome shaped impeller hub 410 from the airflow inlet 224. Air at the inlet is travelling in a direction parallel to the axis of the impeller rotation (vertically, when the impeller is mounted in a ceiling fan) and enters the impeller hub 410 closest to its centre and the root portions of the continuous blades 420. Air is subsequently driven forward by the impeller blades 420, 422 from the blade root end 434 to the blade tip end 432. As air travels through the impeller 400, the flow direction changes by centripetal acceleration and by following the profile of the blades 420, 422 so that the flow direction changes from being parallel to the axis of rotation to being perpendicular to it in all directions. The outflow air stream 180 leaving the tip end 432 of the blades travels through the outlet passageway 168 defined between outlet gap 172.

While the centrifugal impeller 400 of the preferred embodiment has been described to operate in a clockwise rotation, it is to be understood that the impeller 400 is not limited to this orientation and may also be operated in an anti-clockwise rotation. In some experiments, it has been observed that operating the impeller 400 in the anti-clockwise rotation provided higher airflow volume and velocity at the primary airflow outlet.

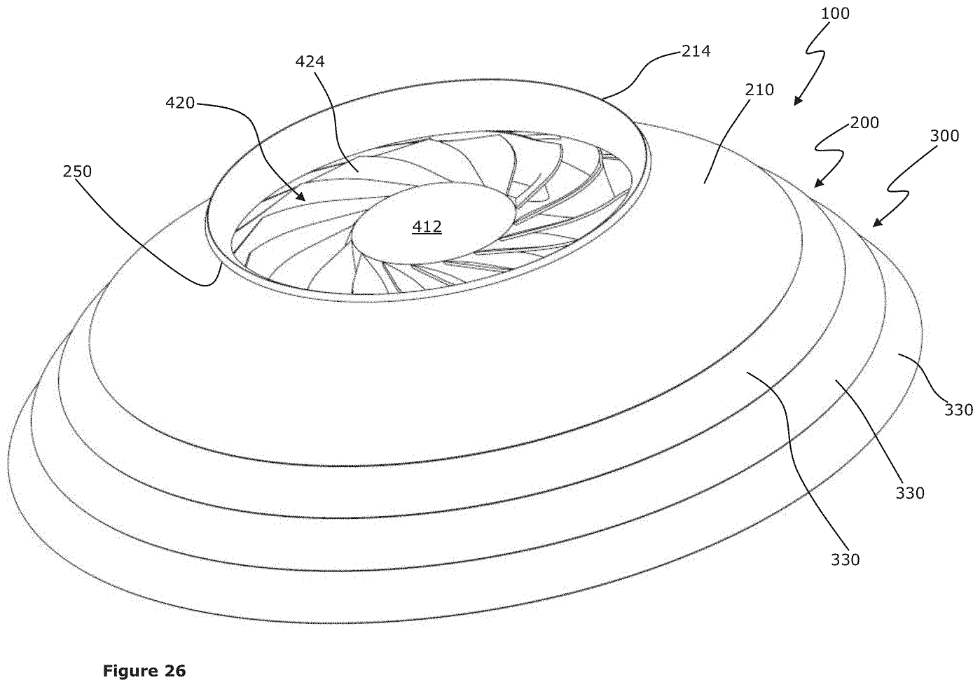

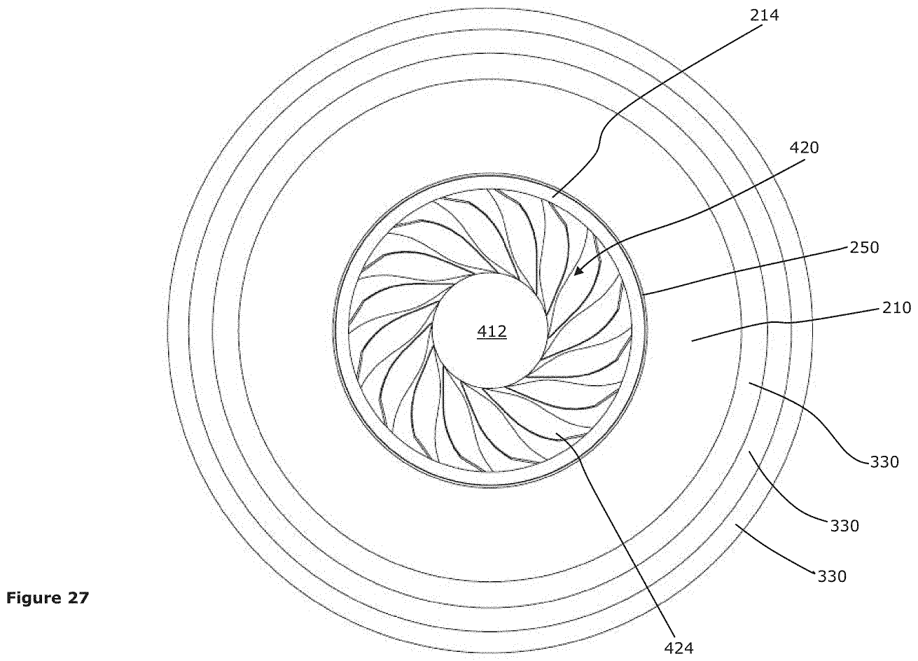

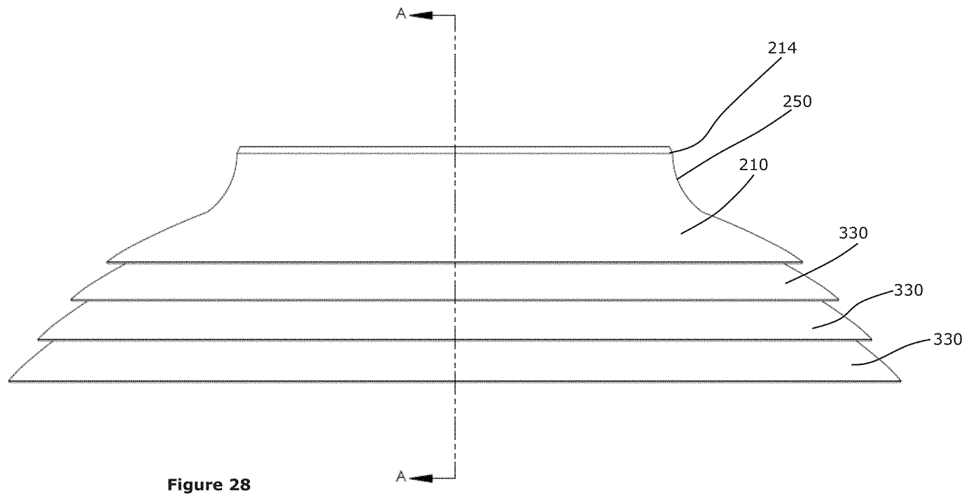

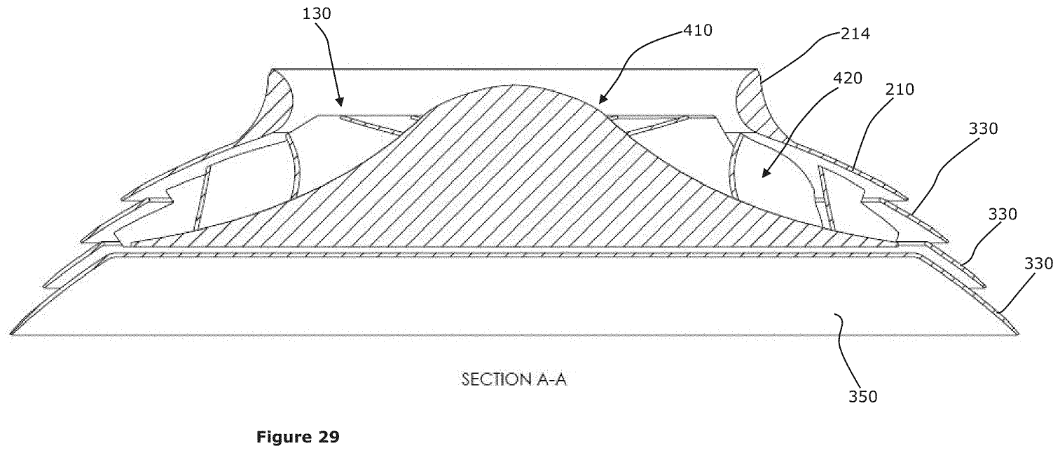

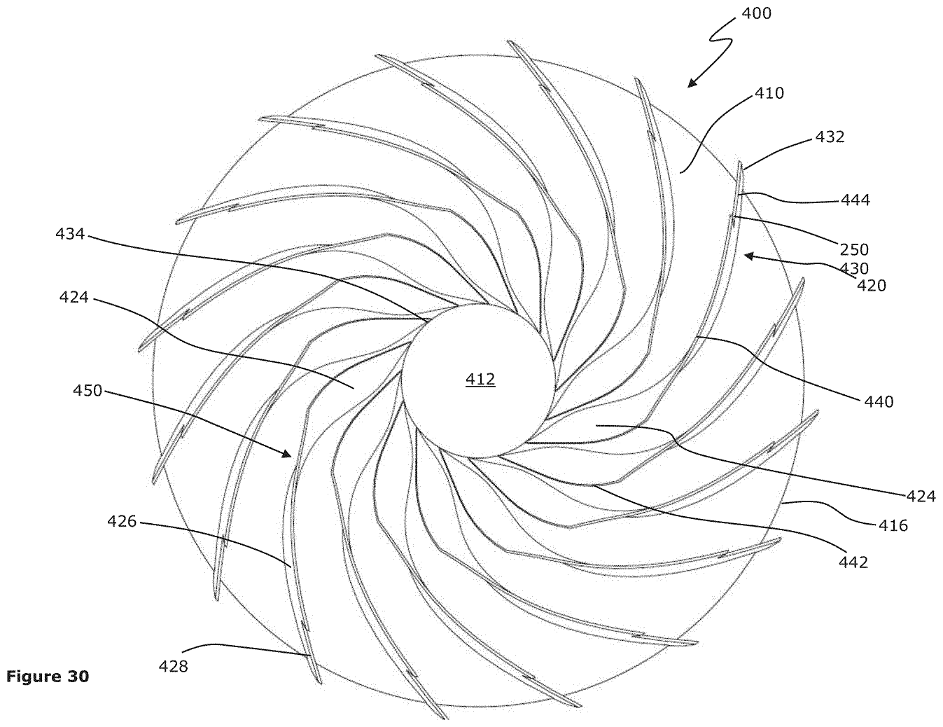

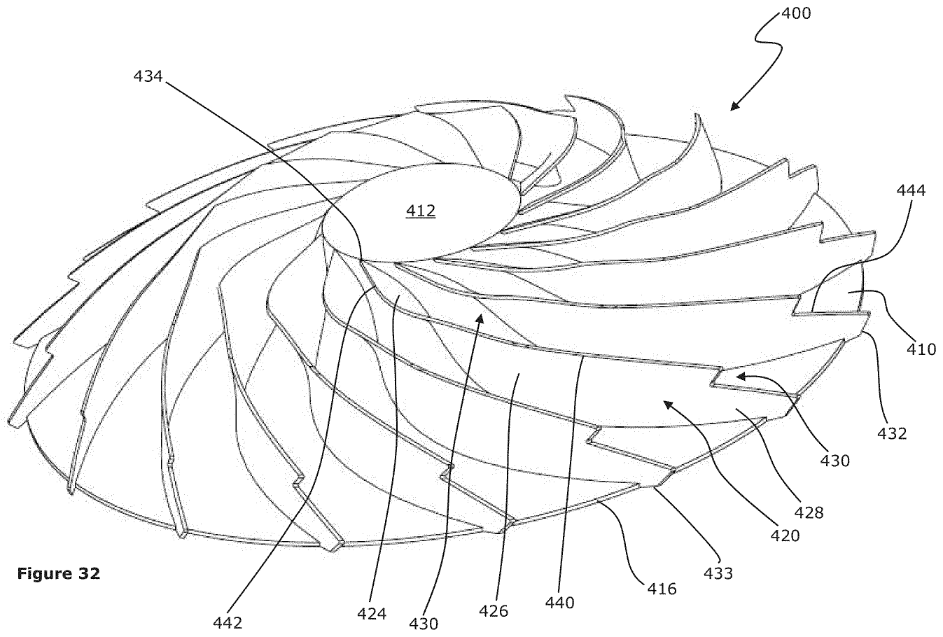

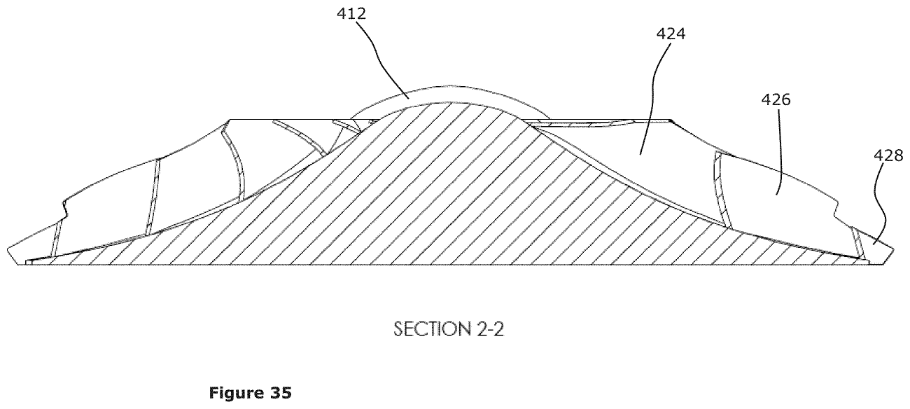

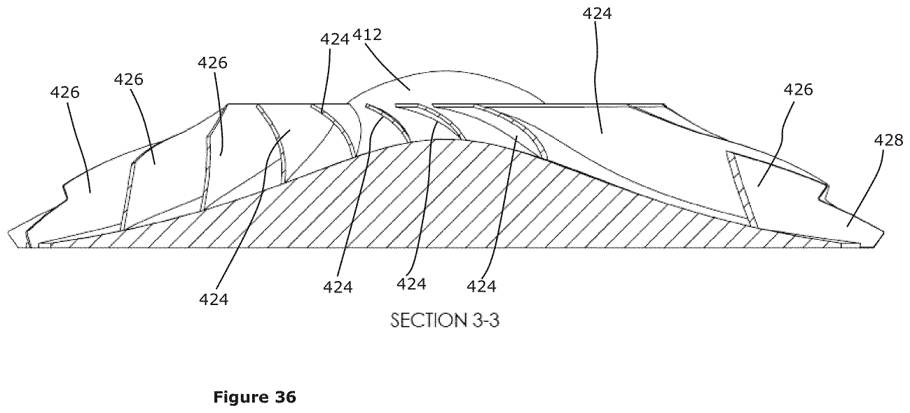

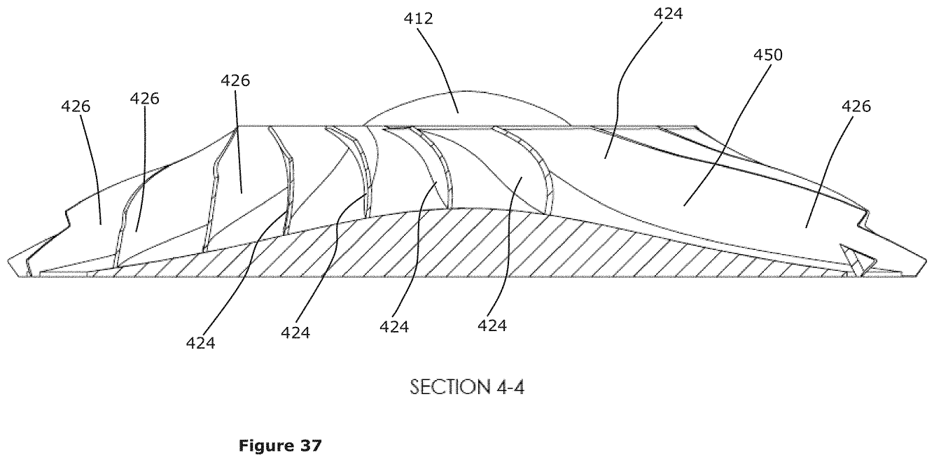

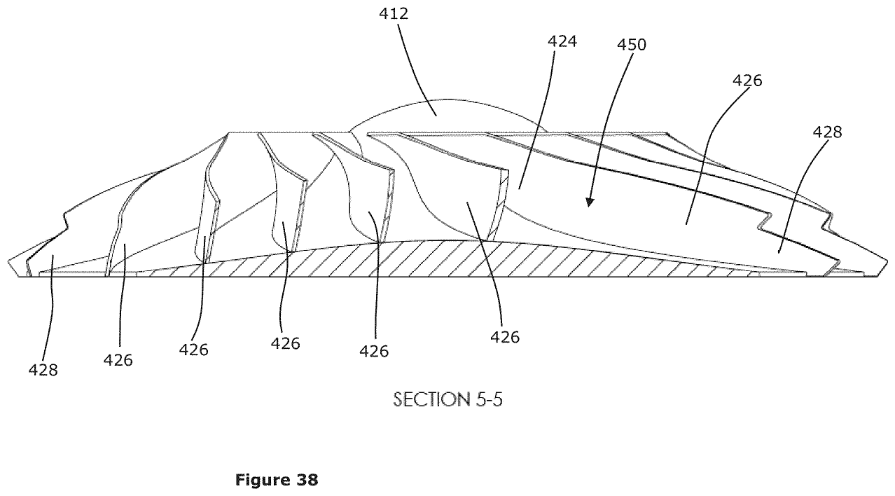

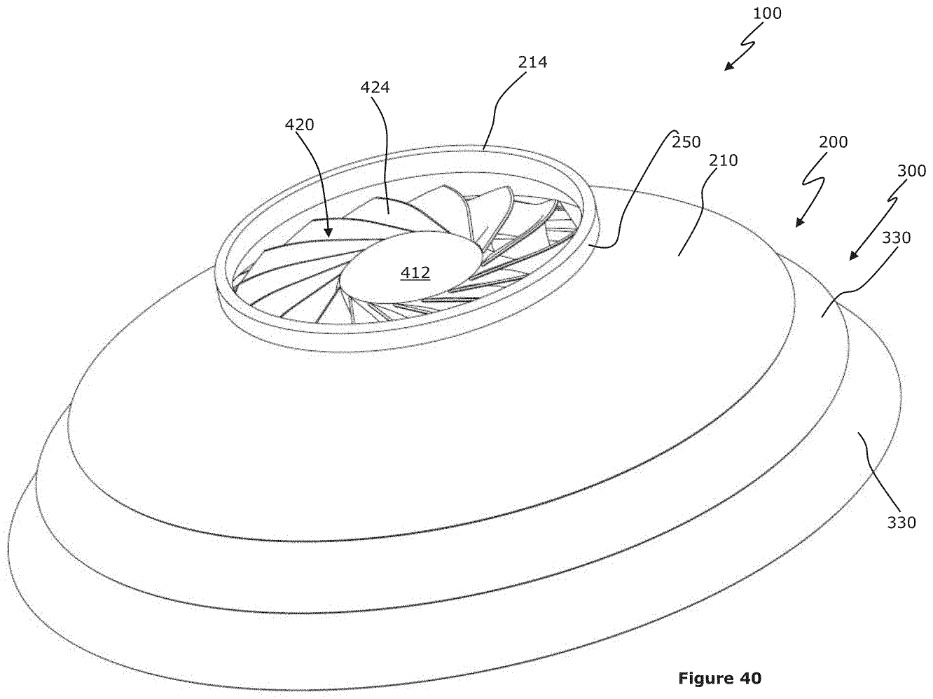

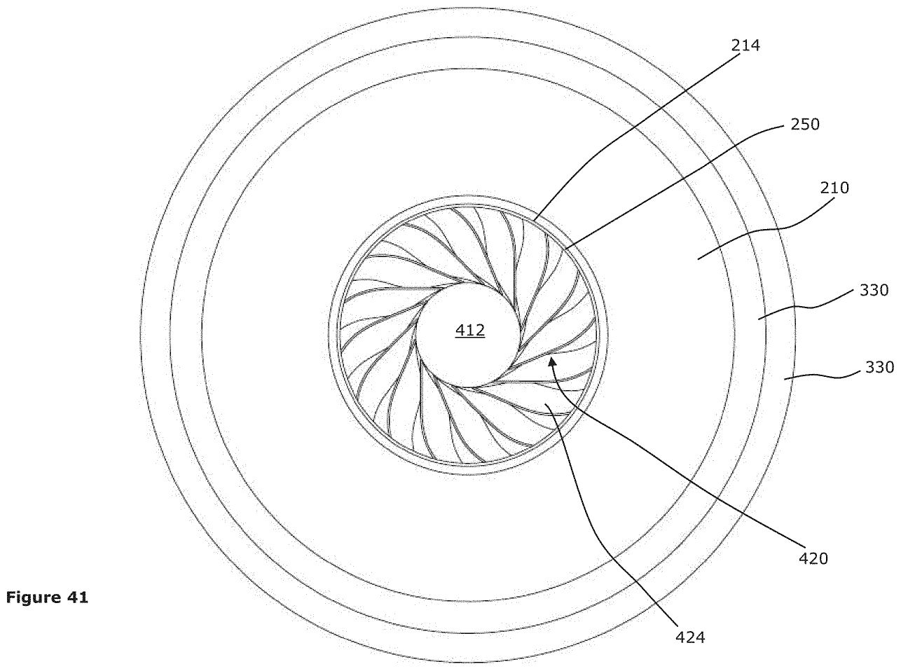

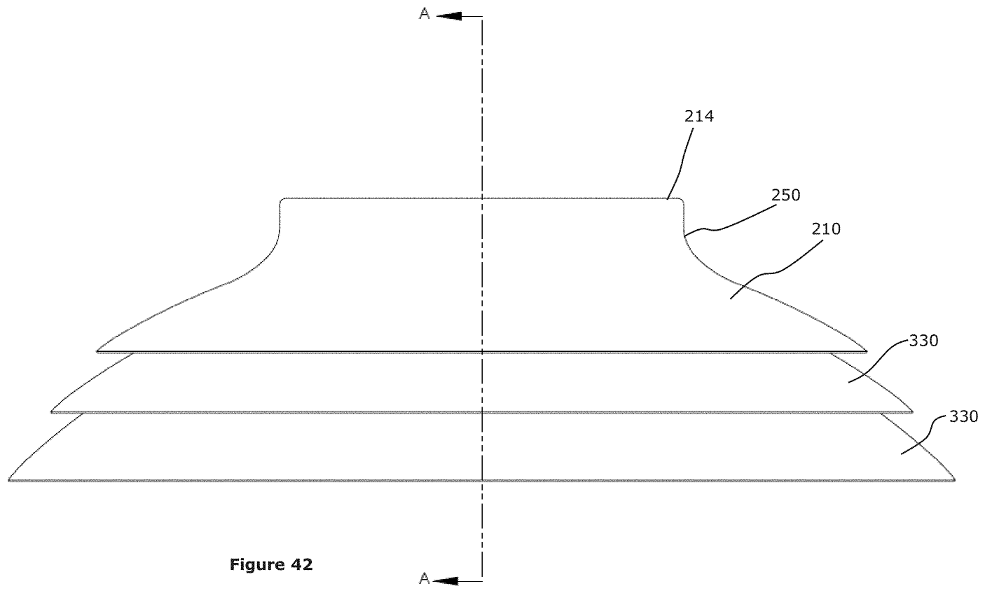

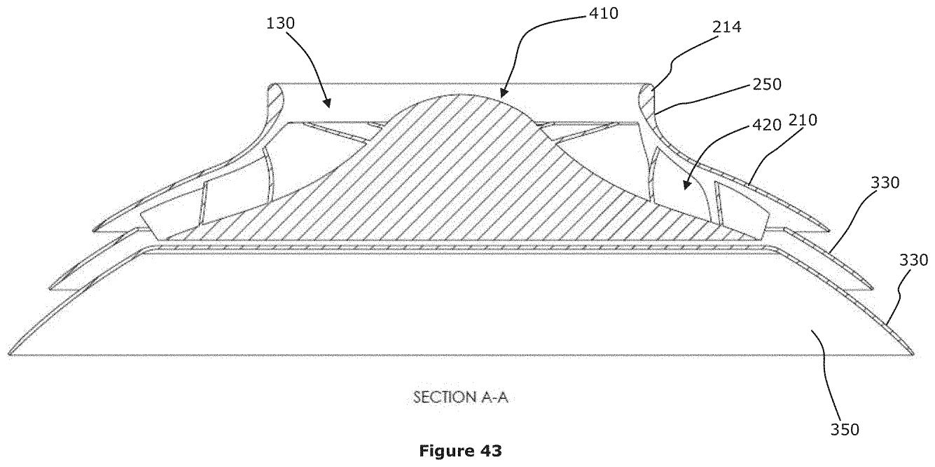

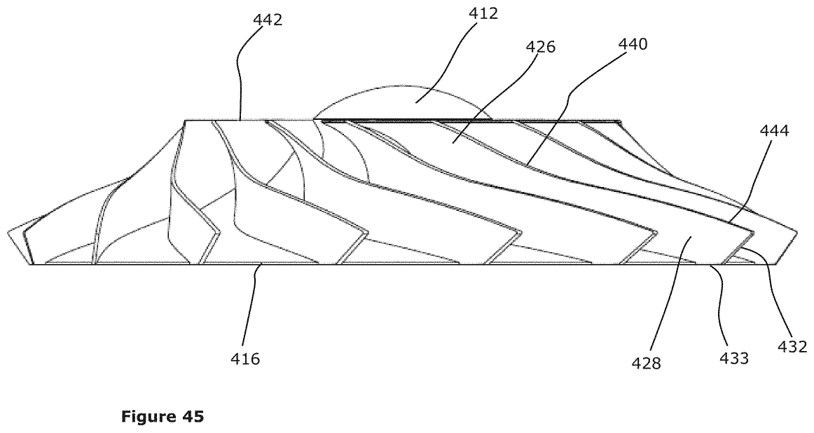

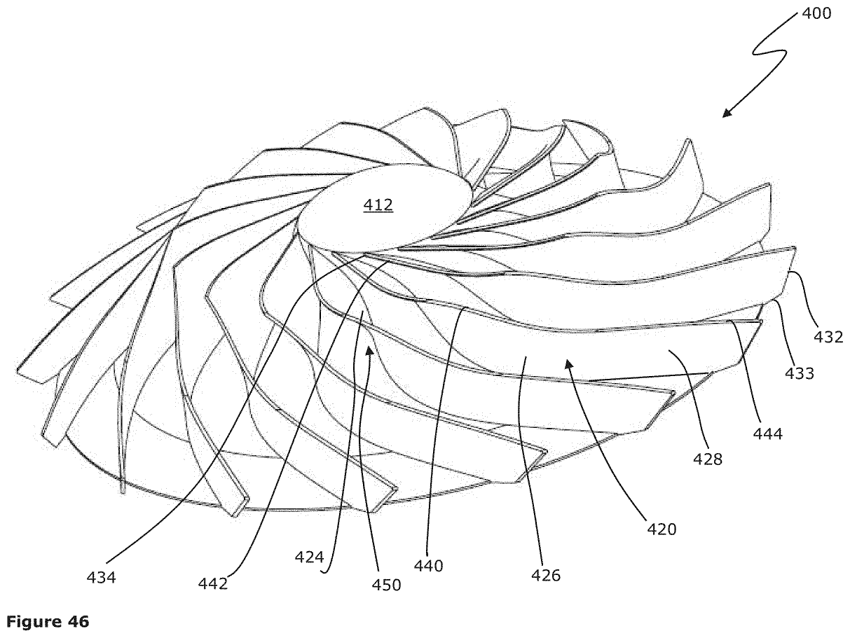

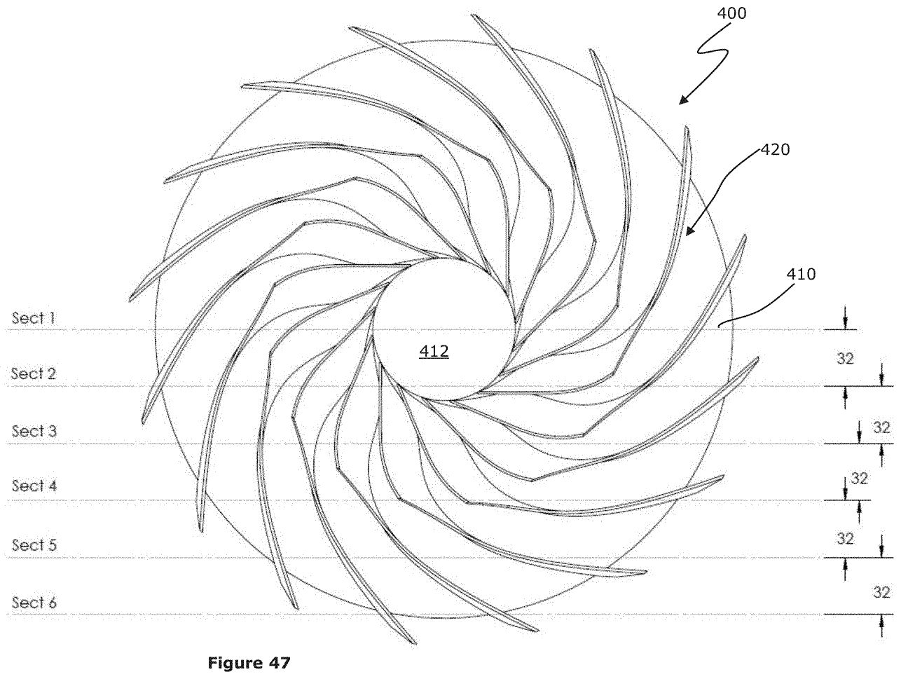

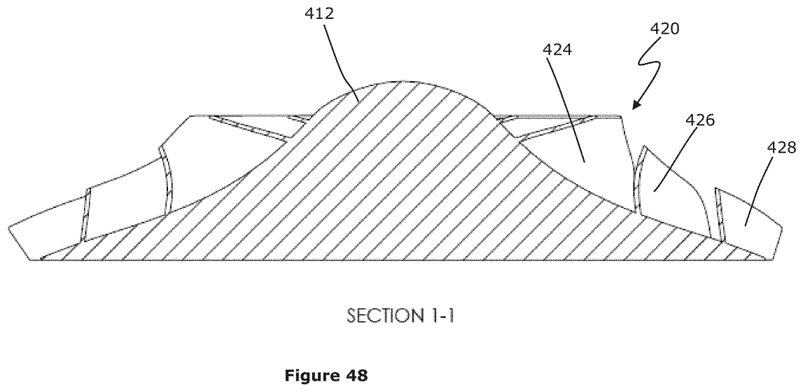

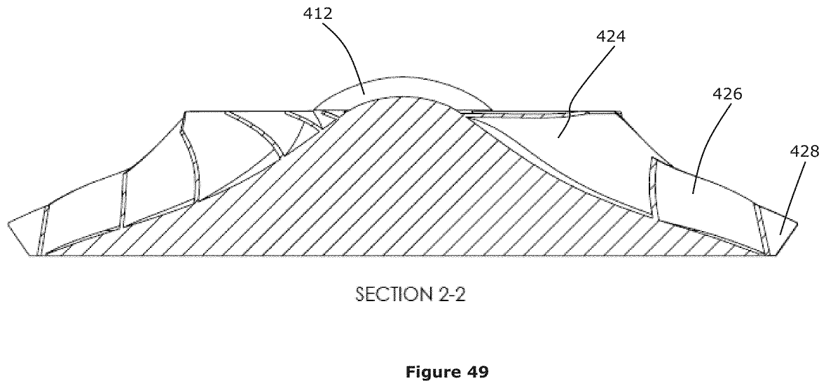

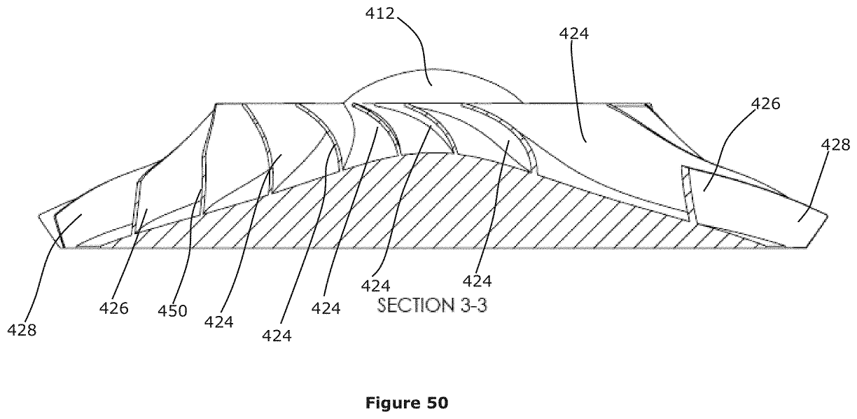

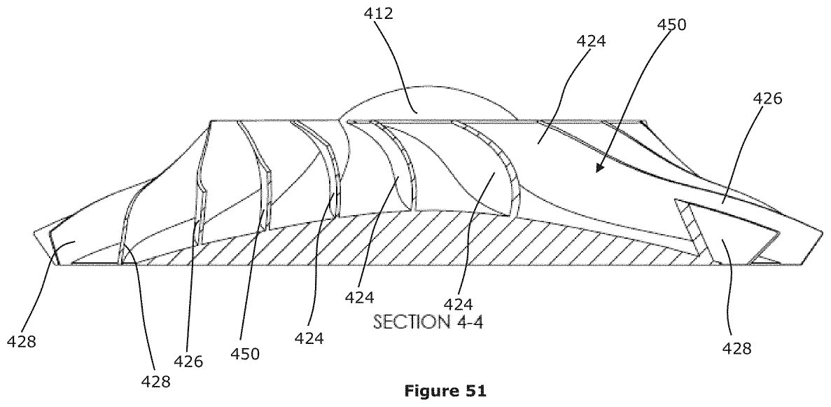

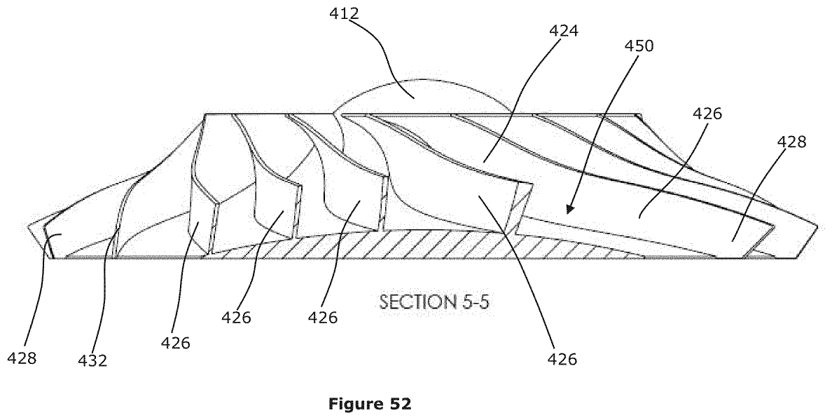

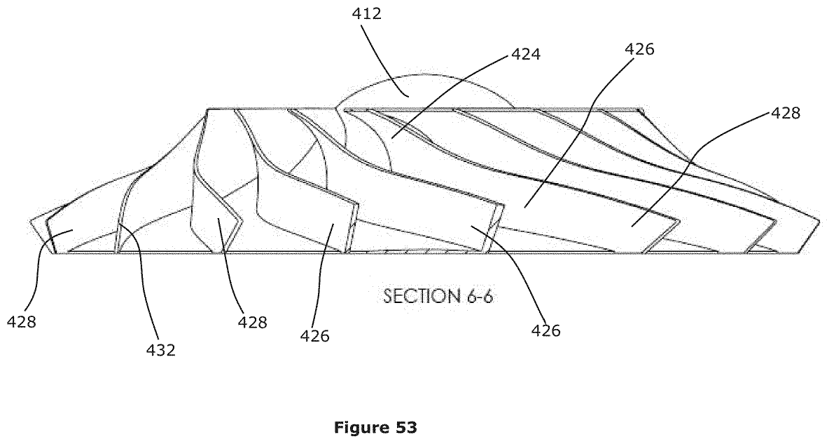

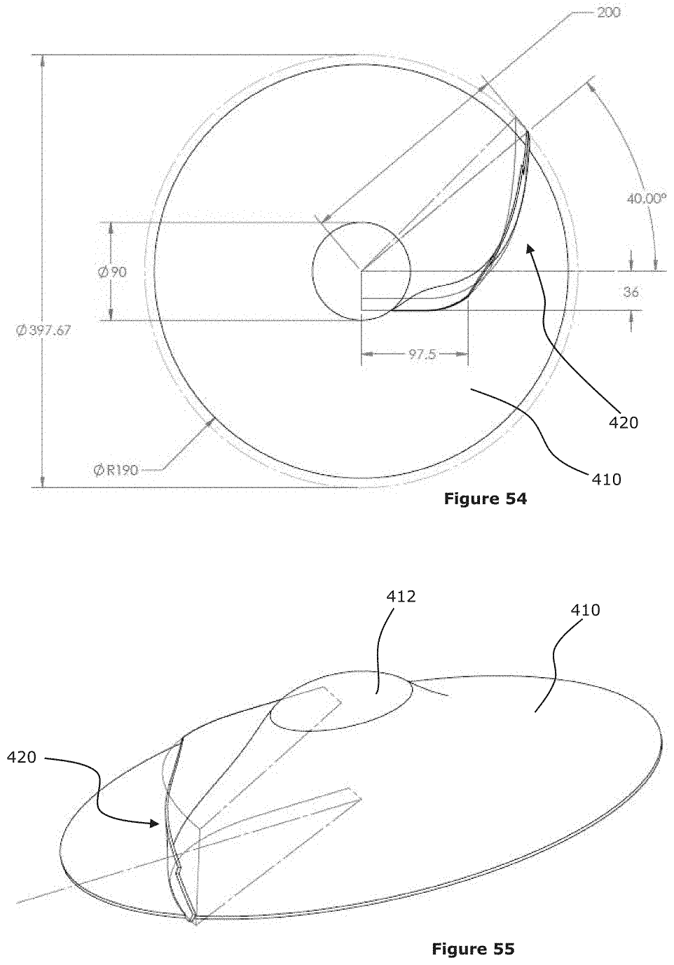

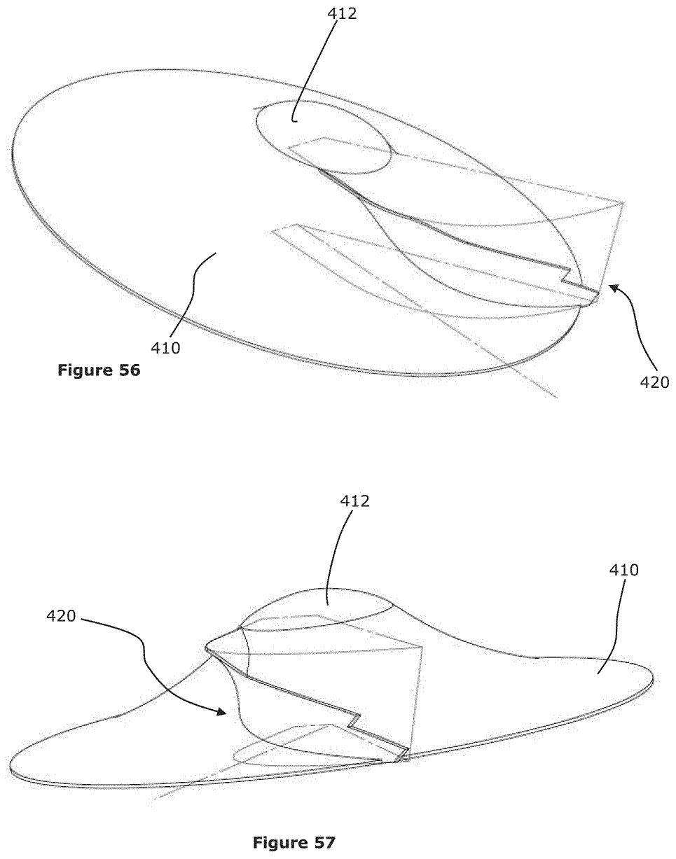

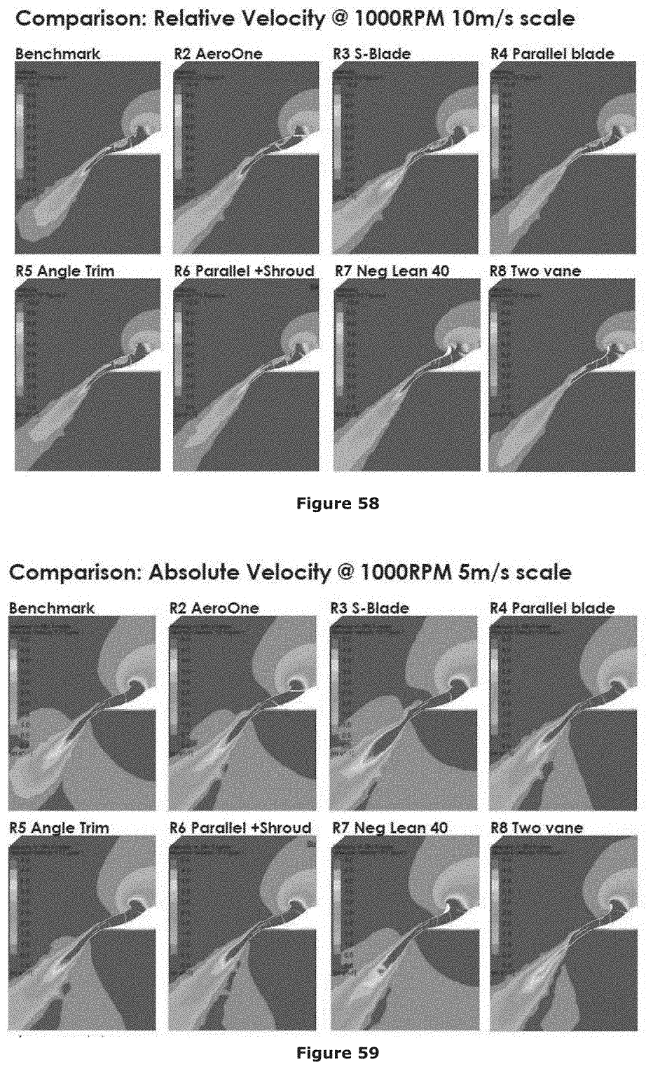

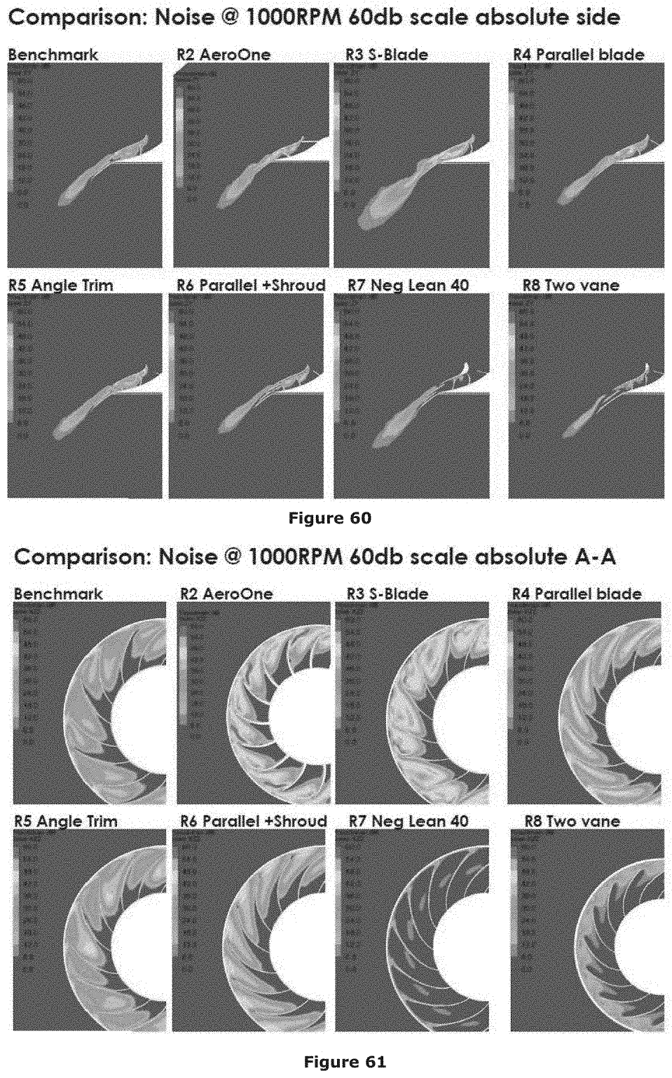

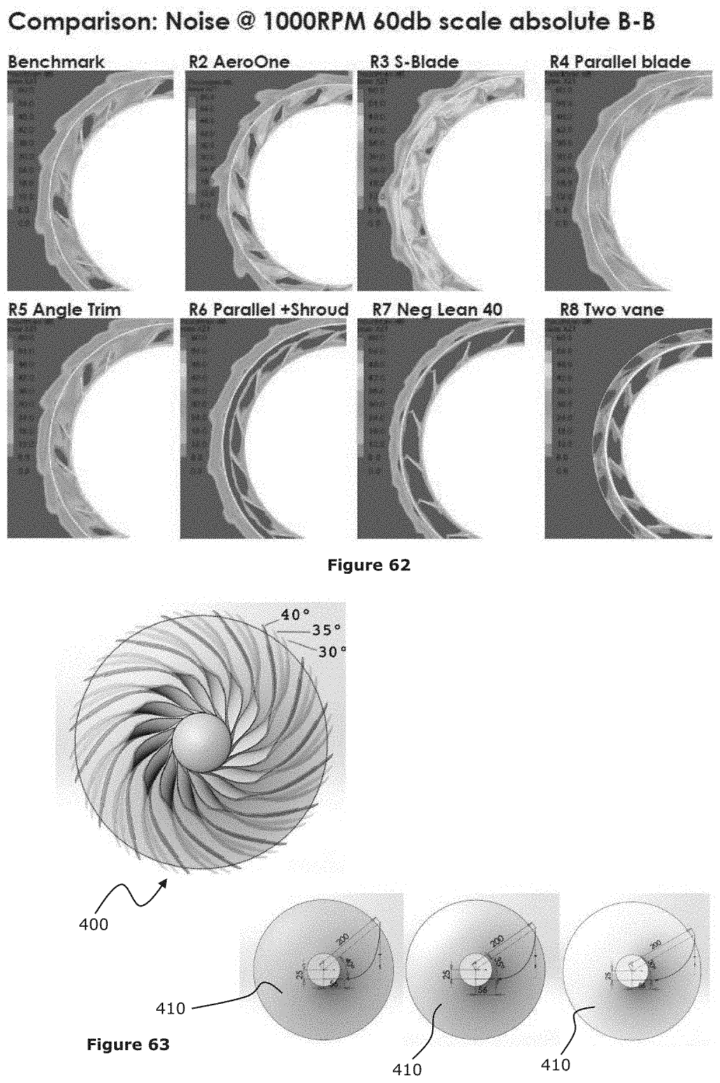

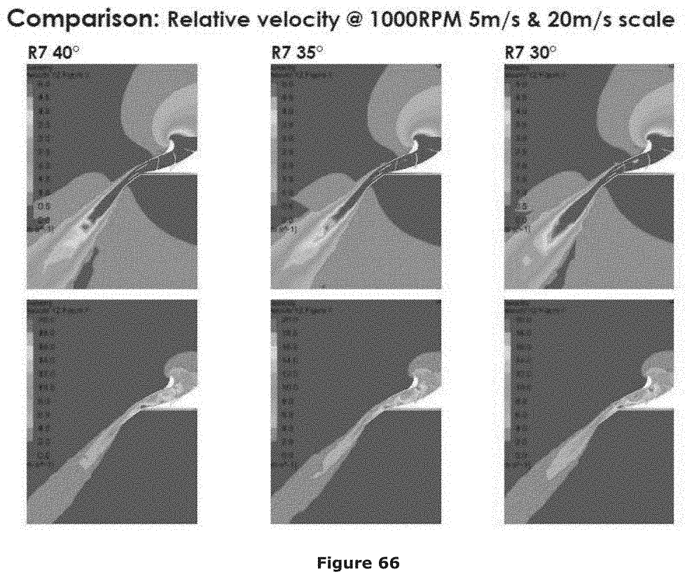

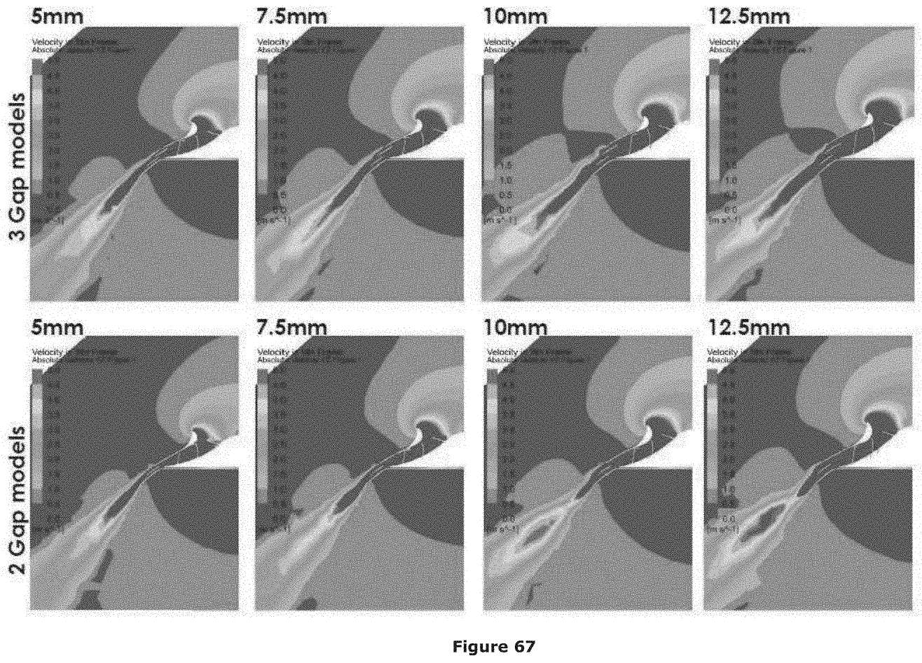

Additional embodiments of a centrifugal impeller 400 are shown in FIGS. 26 to 39, FIGS. 40 to 53 and FIGS. 54 to 57, experimental data supporting the efficacy of the additional embodiments are shown in FIGS. 58 to 66. More specifically, FIGS. 26 to 39 show a centrifugal impeller 400, labelled in the Figures as the R7 variant, for use with a housing 200 and three layers of vanes 300 as described earlier, and FIGS. 40 to 53 show an impeller 400, labelled in the Figures as the R8 variant, for use with a housing 200 and, two layers of vanes 300. FIGS. 54 to 57 show various views illustrating a single continuous blade 420 of the R7 variant impeller 400. FIGS. 58 to 62 show fluid modelling data comparing the performance of the R7 and R8 variants with earlier impeller designs in relation to relative velocity, absolute velocity of airflow leaving the fan assembly 100 and noise measurements, while FIGS. 63 to 66 show a comparison of key measurement parameters for an R7 variant impeller 400 having chord angles of 30°, 35°, and 40°. Referring to FIG. 54, the chord angle refers to the angle formed between a first chord extending from the root end 434 of the blade 420 with respect to an arcuate path followed by the blade 420 and a second chord extending from the centre of the hub 410 and the tip end 432 of the blade 420.

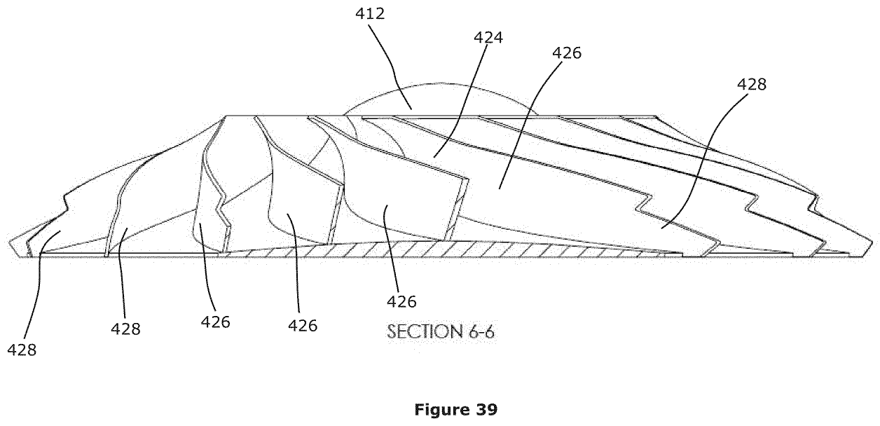

Returning to FIGS. 26 and 39, the R7 variant impeller 400 comprises a rotatable impeller hub 410, which is mountable to the motor 120 by way of an impeller mount 402, to which the impeller hub 410 is fastened. The impeller hub 410 is of a general dome shape having a raised centre in the form of a hub dome 412 and the height of hub 410 transitions smoothly from its highest point at or about the hub dome 412 to its lowest point which is at the peripheral (circumferential) edge of the hub 410 (see FIG. 34). The impeller 400 comprises a single set of continuous blades 420 positioned on the hub 410. Each continuous blade 420 extends from a blade root end 434, which is located closer to a central hub dome 412, radially outwards towards the hub peripheral edge 416, during which the blade 420 transitions between three distinctive geometry stages—a blade root portion 424, a blade mid portion 426 and a blade end portion 428.

At the blade root portion 424, the blade 420 is configured with a “positive lean”, that is a top portion of the blade root portion 424 is curved toward the direction of a clockwise rotation of the impeller 400 so as to be substantially flattened at an end closer to the hub dome 412. This initial curvature and configuration of the blade 420 helps draw airflow from the vent 130 or an air inlet downwardly into the impeller 400 and disperse the airflow through channels formed between adjacent blades 420. The top portion of the blade root portion 424 and its positive lean configuration results in the airflow channels formed between adjacent blades 420 being at least partially covered by the blade root portion 424, which reduces the occurrence of air flowing between the channels and therefore reduces turbulence. The positive lean of the configuration of the blade root portion 424 progressively adjusts back to a neutral position 450 along the length of the continuous blade 420, in which the blade 420 is substantially upright as opposed to lean any one side to the other. It is at or about this neutral position 450 of the blade 420 that the blade 420 then turns into a “negative lean” configuration. Negative lean can be understood as the blade 420 body curving away from the direction of a clockwise rotation of the impeller 400. The transition between the positive and negative lean geometries of the blade 420 along its longitudinal length provides the appearance that the blade 420 twists along its length between the blade root end 434 and the blade tip end 432. It has been found that the negative lean configuration of the mid portion 426 and end portion 428 of the blade 420 advantageously reduces noise pressure generated by the impeller 400 during use.

Referring to FIGS. 54 to 57, the positive lean of the blade root portion 424 is be greater than the negative lean of the blade mid portion 426 and the blade end portion 428. In one embodiment, the blade 420 transitions from the position lean configuration to the negative lean configurations at or about a neutral position 450, though it is to be understood that the blade 420 may also be configured so as to continue in a neutral upright position for some distance before transitioning to a negative lean configuration at the blade mid portion 426 and/or the blade end portion 428. It is to be understood that the described impeller blade 420 configuration has been designed for a clockwise rotating impeller and the geometries and configurations may be inversed for an anti-clockwise rotating impeller.

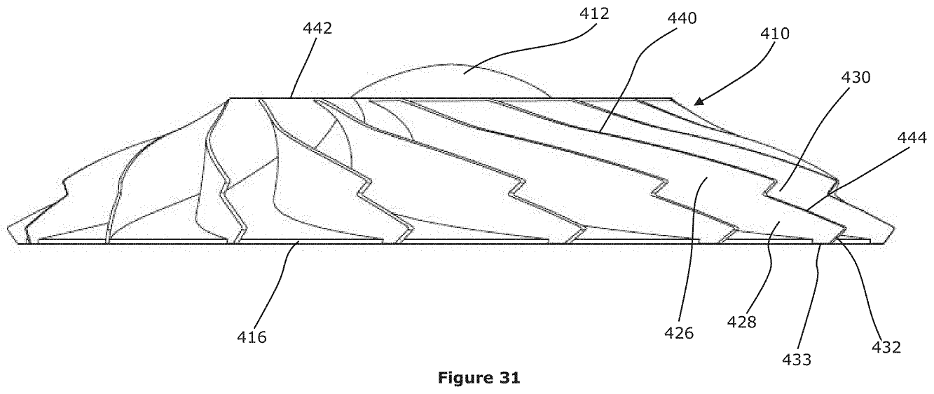

The continuous blade 420 also comprises spine portions 442, 440, 444 which follow the contours of the blade body along the length of the blade 420, though in general the spine of the blade 420 reduces in height along the length of the blade from the blade root end 434 to the blade tip end 432. Specifically, the root portion spine 442 maintains a substantially equal height along the root portion 424 of the blade before the transition to neutral point 450 and/or negative leaning mid portion 426 of the blade so that the root portion 424 of the blade covers a substantial portion of the vent inlet 130. It is noted that the root portion spine 442 maintains the height of the blade 420 across the vent inlet 130 even though the impeller hub 410 is sloping towards its periphery edge 416. The mid portion spine 440 of the blade mid portion 426 then progressively reduces in height from or about the neutral point 450 toward the blade end portion 428 and the blade tip end 432. In the R7 impeller variant, as shown in FIGS. 30 to 39, a blade step 430 as described previously is similarly provided between the blade mid portion 426 and the blade end portion 428 so as to accommodate an adjacent louvered vane 300 and provide improved airflow through the adjacent louvered vane 300.

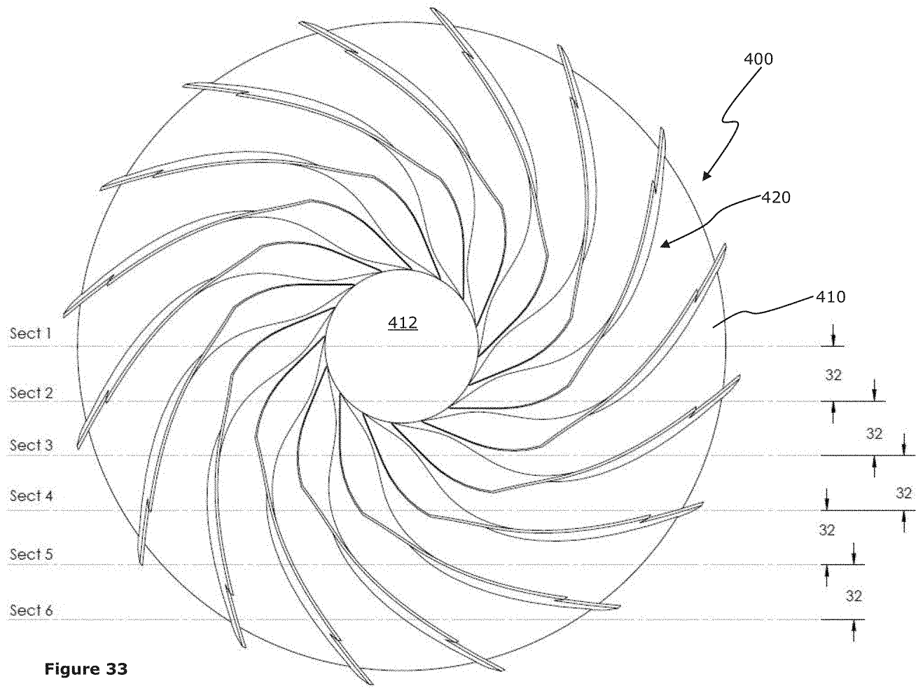

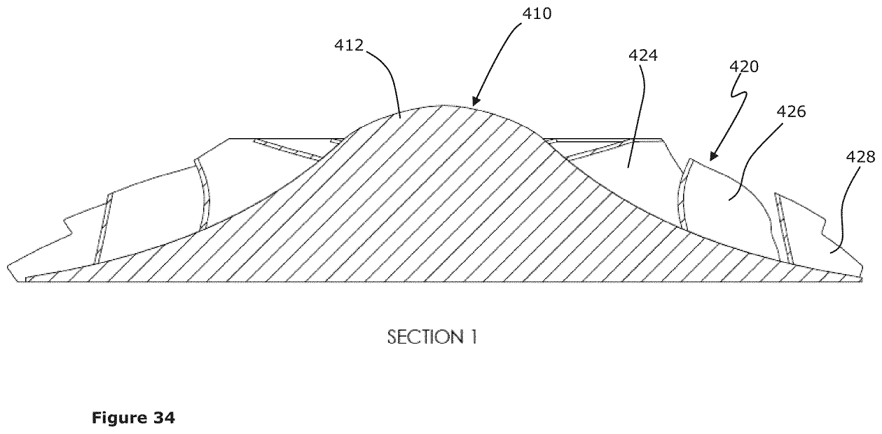

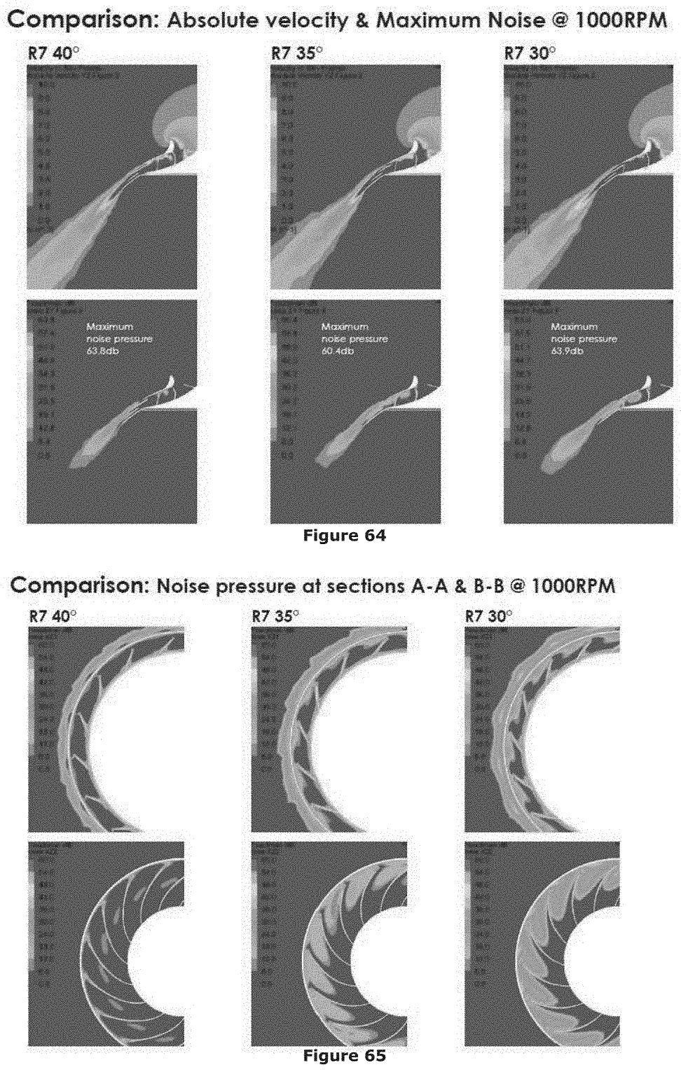

The R7 variant impeller 400 comprises a plurality of like continuous blades 420 described above evenly positioned on the impeller hub 410 about the hub dome 412. In one configuration, the impeller comprises 16 like blades 420. FIGS. 33 to 39 show sectional views of the blades 420 as assembled on the impeller hub 410. Referring now to FIGS. 63 to 66, it has been found that the chord angles of the blades 420 influence the output velocity of the impeller 400 at the blade tip end 432. The chord angle as used in the context of the impeller blades 420 of the present invention refers to the angle which governs how far the blade tip end 432 curves backwards from the blade root end 434 and/or the blade root portion 424 as shown in FIGS. 54 and 63. More specifically, the chord angle measures an angle between a linear part of the blade root portion 424 and a radial line drawn between the blade tip end 432 and the centre of the impeller hub 410 (the centre of rotation). It has been found, as seen in FIGS. 64 to 66, that a chord angle of 40° resulted in significant attenuation of noise pressure. Between the chord angles of 30° to 40°, it has been found that 40° provided an overall reduced in noise while retaining satisfactory absolute and relative airflow velocity profiles.

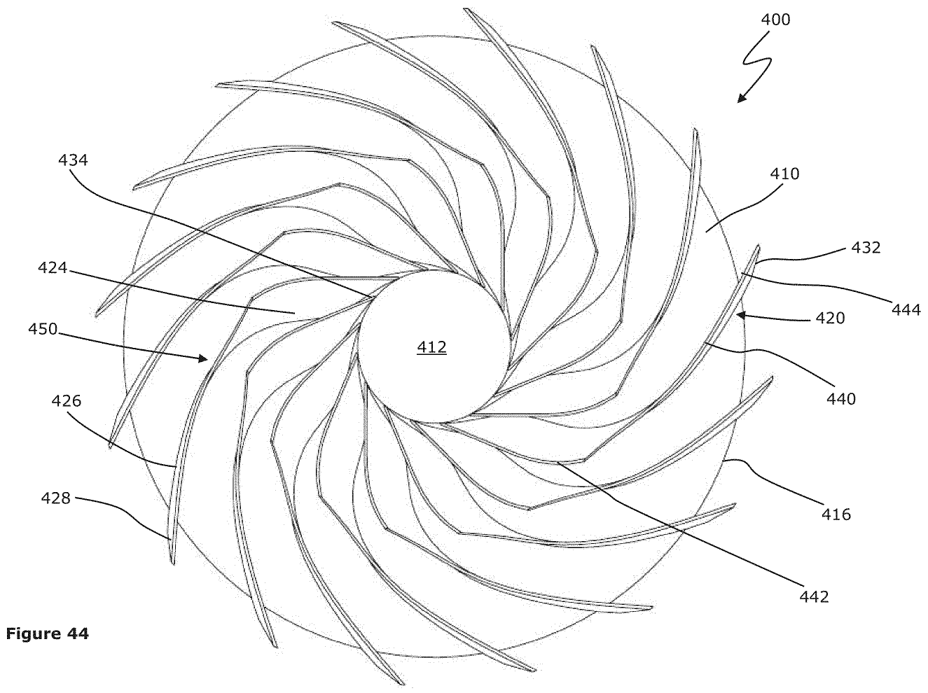

Referring now to FIGS. 40 to 53, another embodiment of the impeller 400 known as the R8 variant is illustrated. The R8 variant of the impeller 400 has been designed to work with a fan assembly 100 having only two layers of louvred vanes 300. In this configuration, it has been found that the blade step 430 is no longer necessary to ensure sufficient airflow through the outlet gap 172 between the vane blades 330, and the air outlets 170. Therefore the R8 variant of the impeller 400 is similar to that of the R7 variant impeller 400 with the primary difference being that the continuous blades 420 of the R8 variant impeller 400 has a smooth transition of the blade body and blade spine between the blade mid portion 426 and the blade end portion 428, as seen in FIGS. 44 to 46, without requiring a blade step 430.

FIGS. 58 to 62 show simulation outcomes based on computational fluid dynamics (CFD) modelling, which were conducted to test a number of impeller designs, including those of the R7 and R8 impeller variants, in relation to airflow velocity and noise performance parameters of the fan assembly 100 in accordance with the present invention. In comparison with the benchmark performance of an earlier described impeller, seven additional impeller configurations were tested. According to the performance output, the R7 and R8 impeller variants as described advantageously produces a most desirable balance of airflow velocity output at the impeller blade tip end 432 and the level of noise produced.

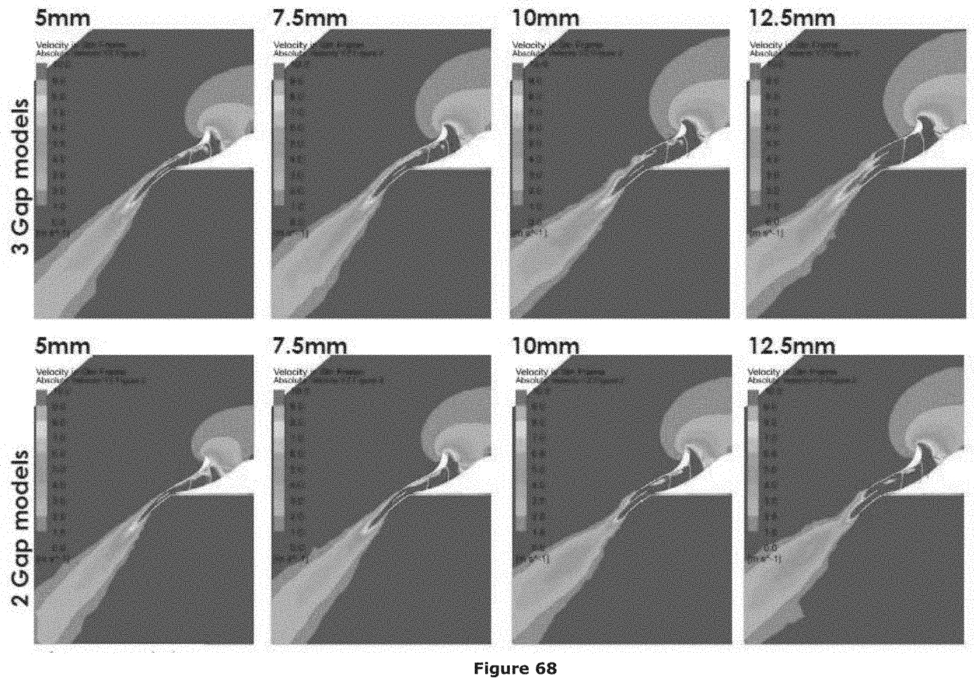

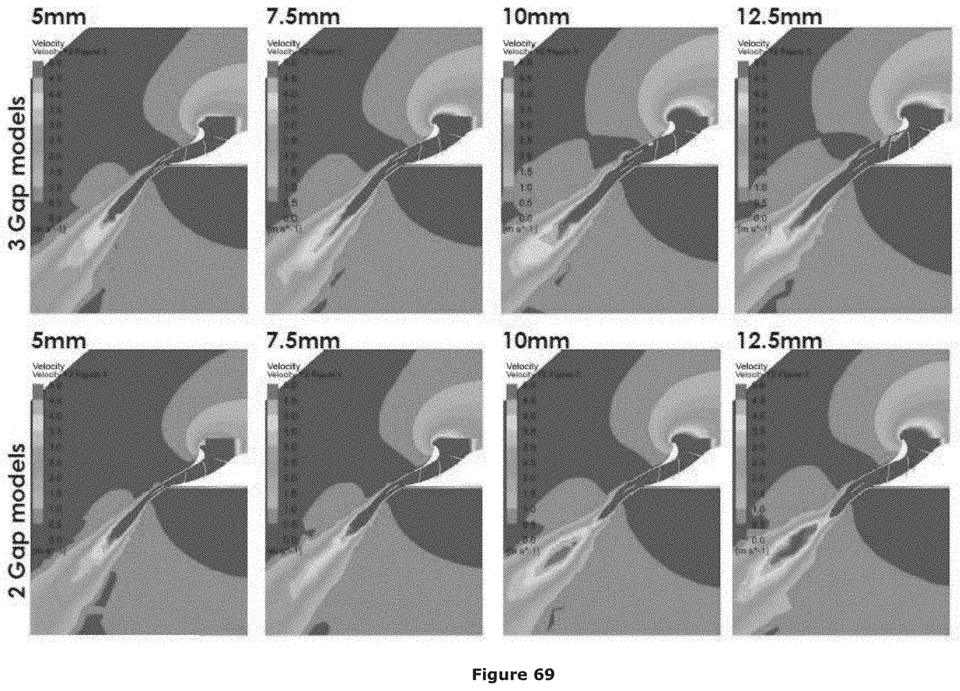

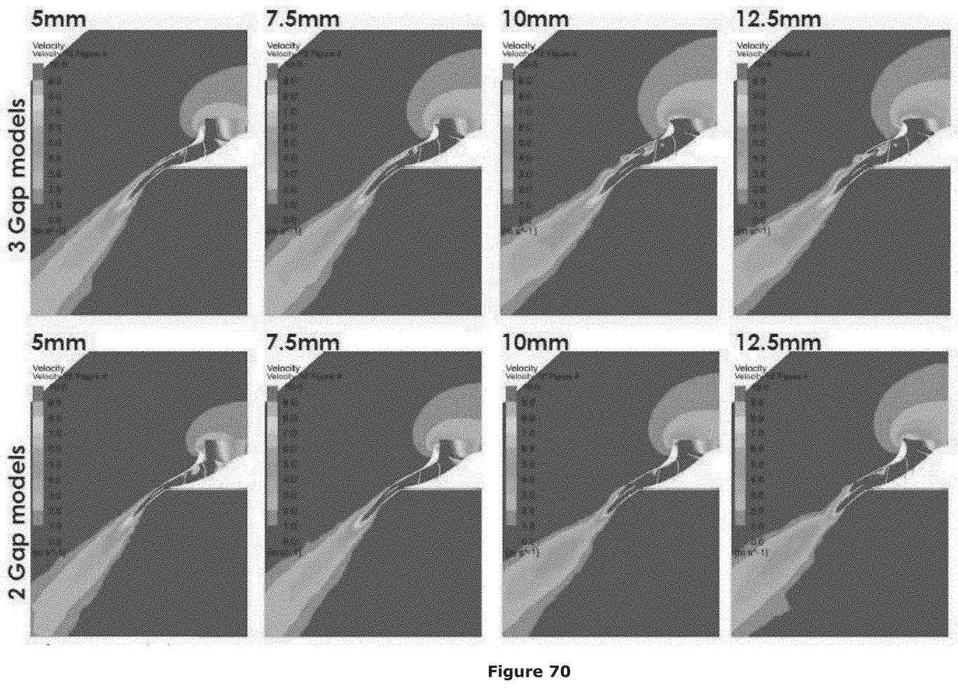

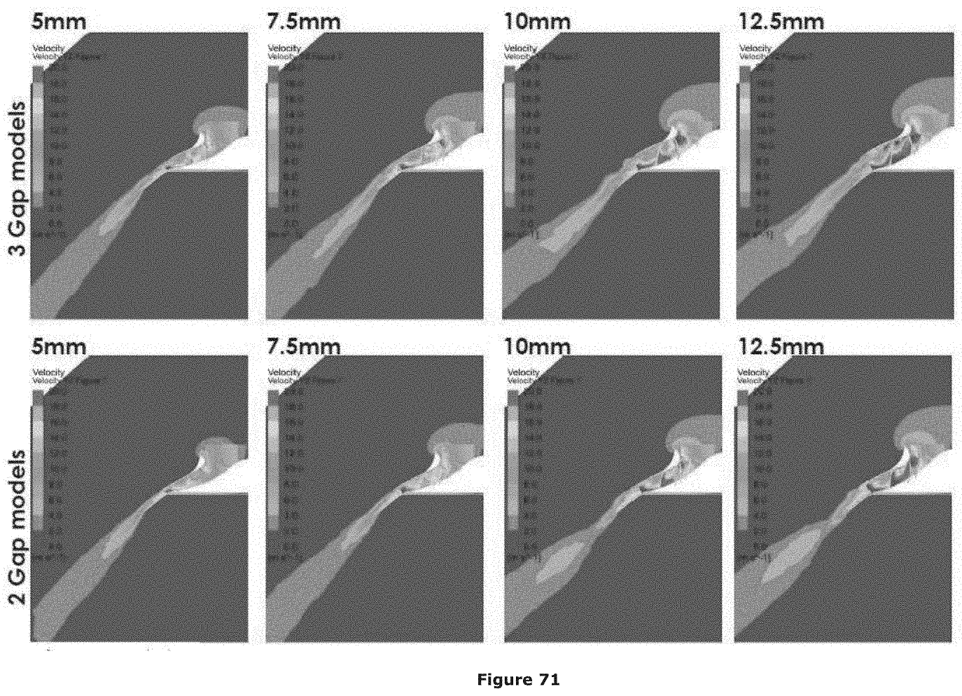

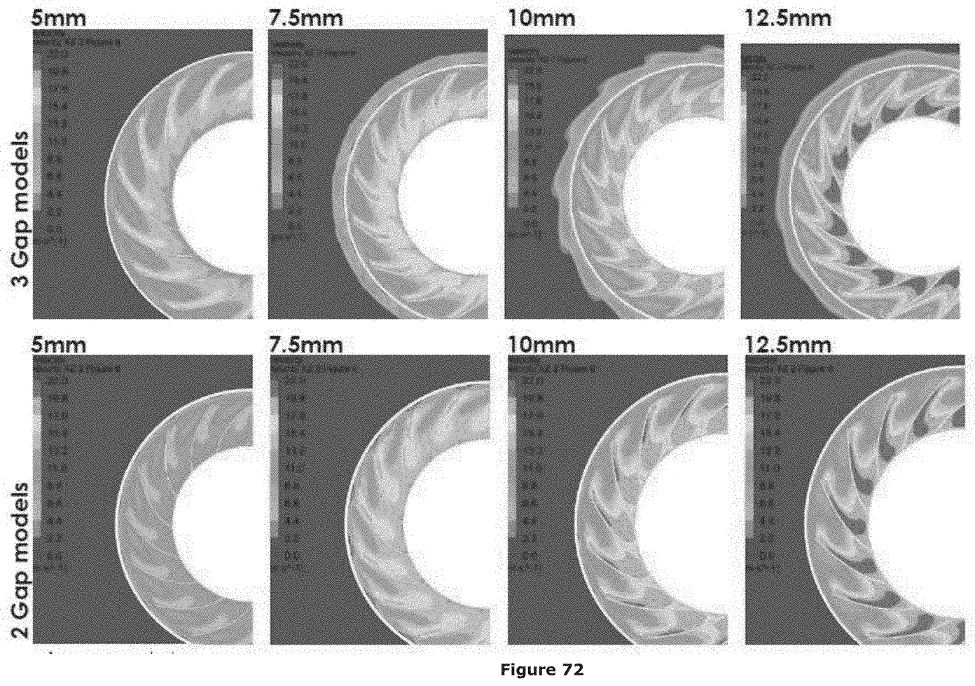

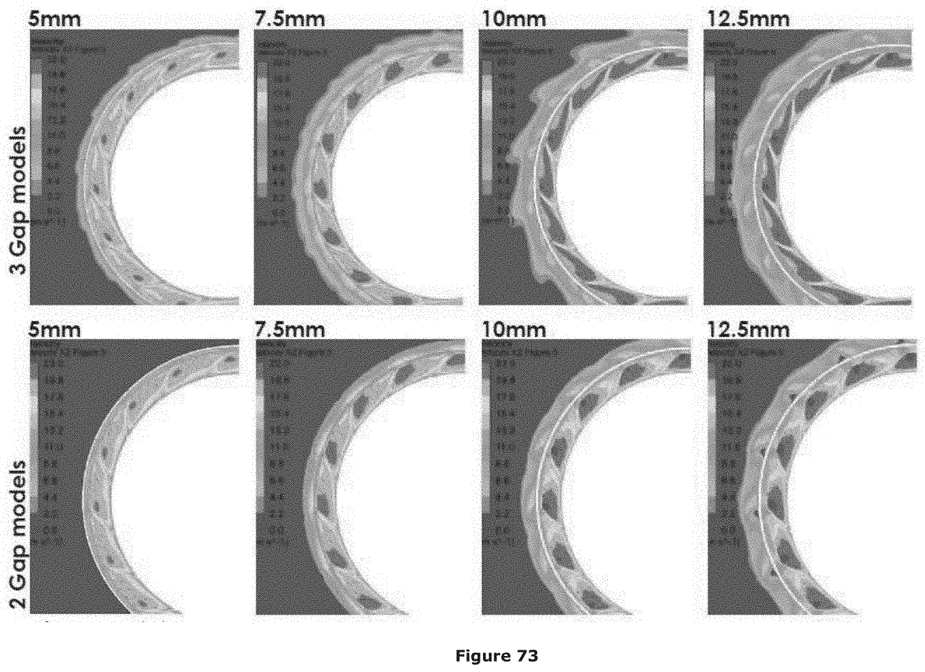

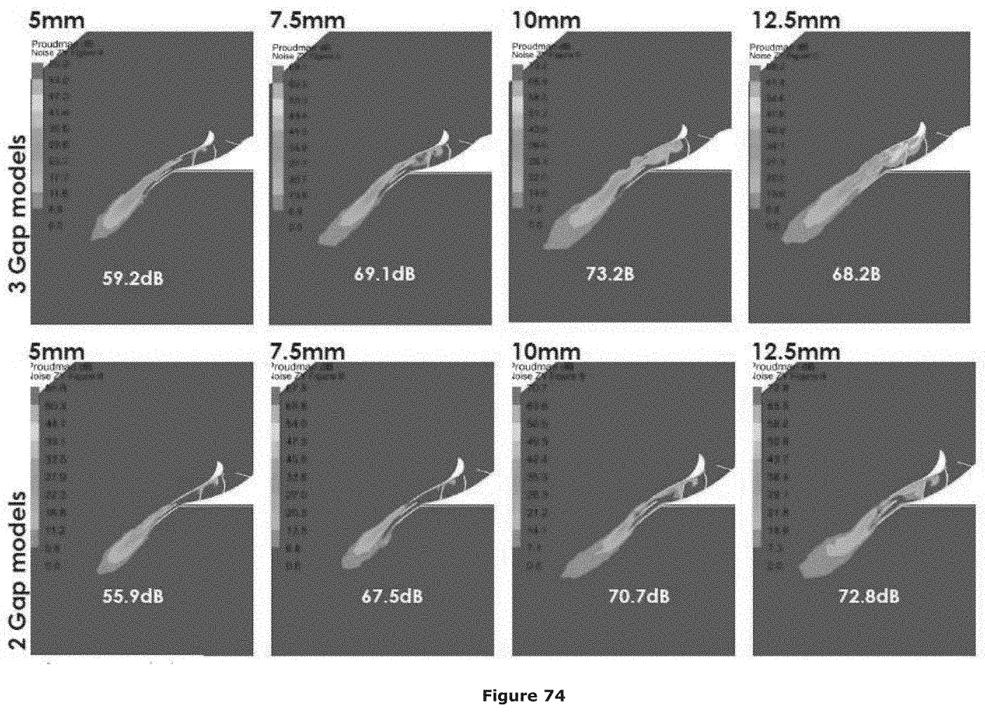

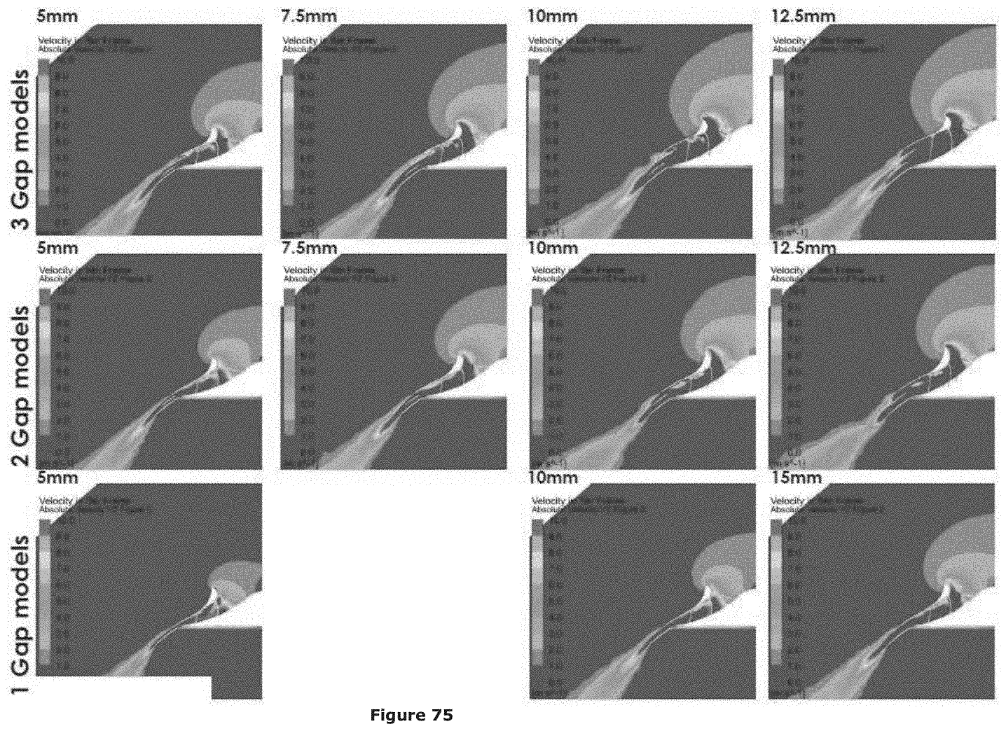

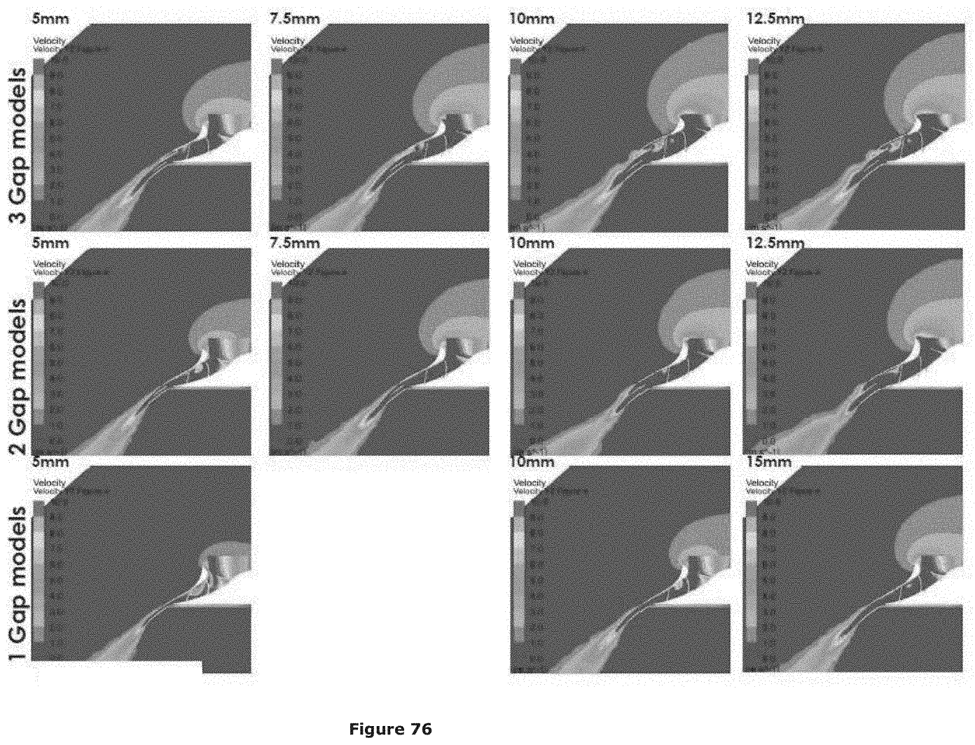

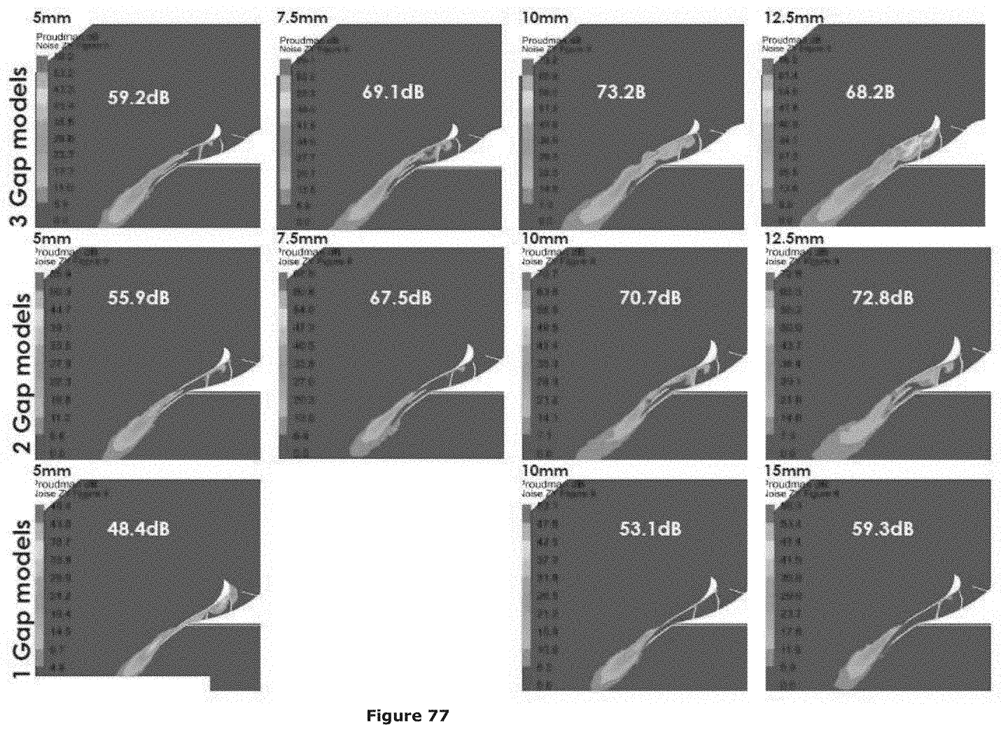

Extensive CFD simulations and testing indicate that there are balancing and trade-off considerations between power efficiency and overall airflow throughput between various configurations of ceiling fan assemblies embodying the present invention. Referring now to FIGS. 67 to 74, further CH) simulations have been conducted with respect to the R7 variant impeller 400 as described above with a housing having annular louvred vanes 300 with three sloped blades 330, and the R8 variant impeller 400 as described above with a housing having annular louvred vanes 300 with two sloped blades 330. Overall, it has been found that increasing the outlet gap size generally resulted in a decrease in desired performance as in all cases, a smaller outlet gap results in lower power consumption but still produced the highest flow ratio and lowest peak noise pressure. All else being equal; the combination of impeller design and louvred vane configurations of the R8 fan assembly variant as described earlier utilised up to 25% less power while achieving between 6% to 10% better flow ratio results when compared with the impeller design and louvred vane configurations of the R7 fan assembly variant as described earlier. However, reducing the number of sloped blades 330 in the louvred vanes 300 further, as seen in FIGS. 75 to 77 clearly resulted in reduced airflow performances while improving overall power usage and peak noise performance.

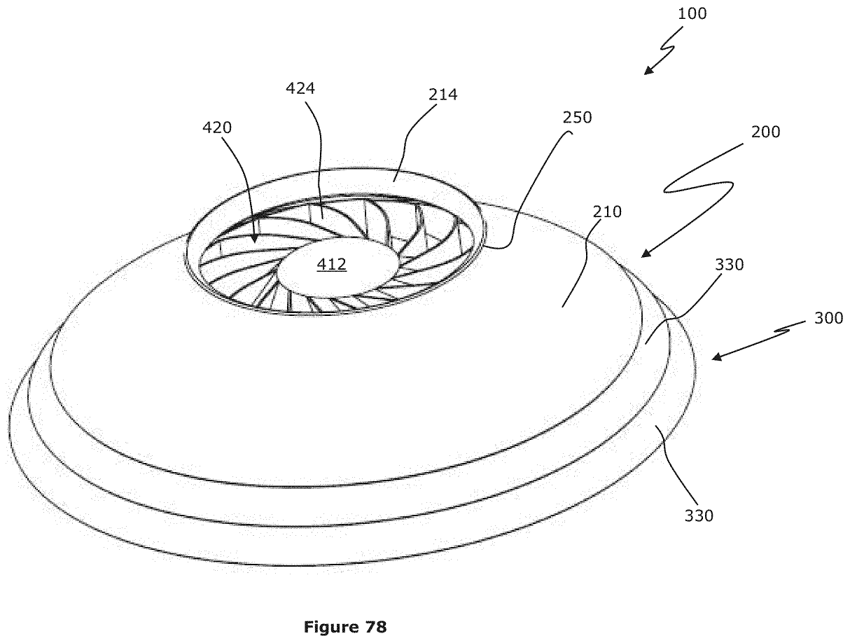

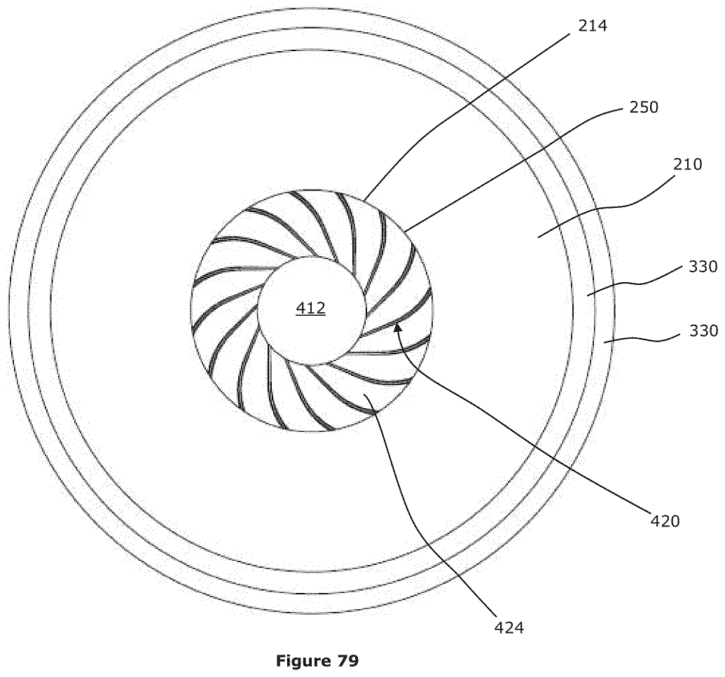

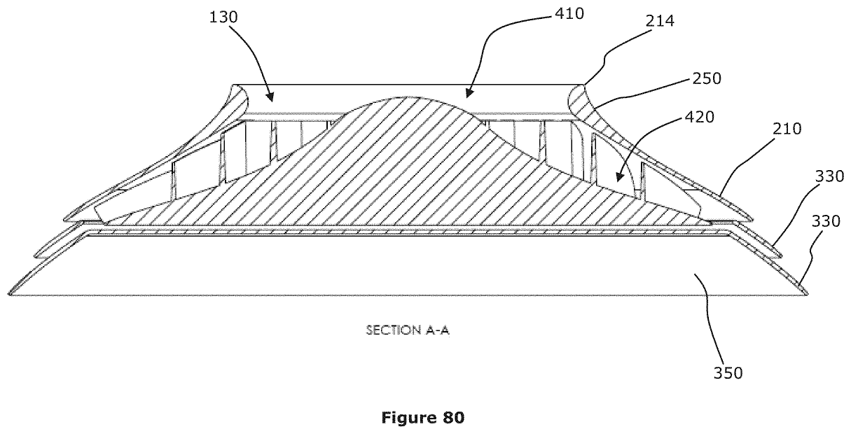

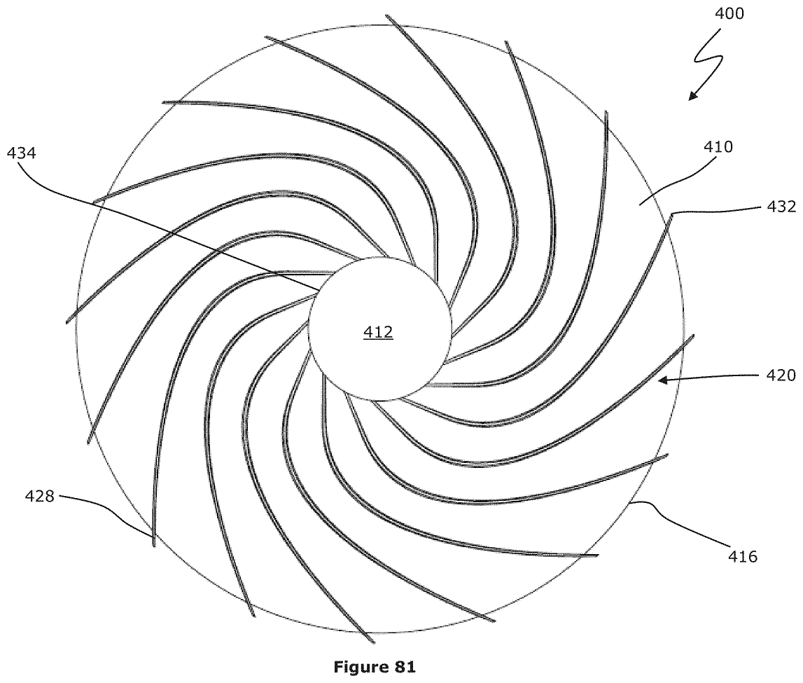

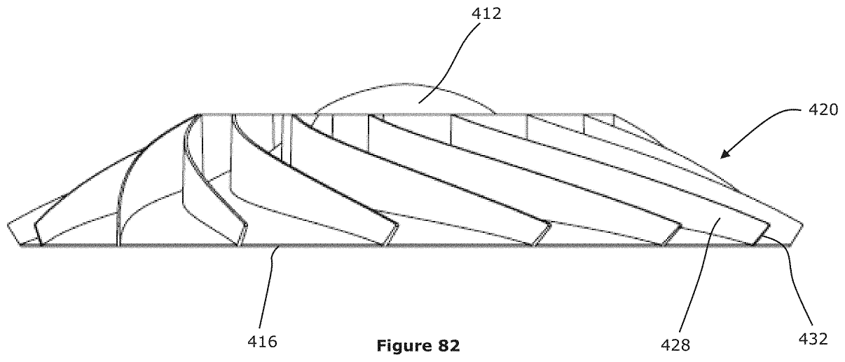

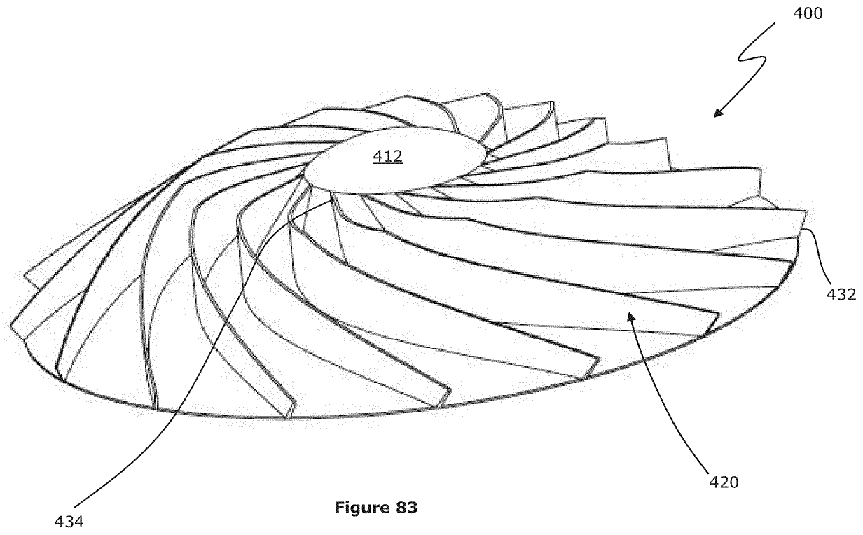

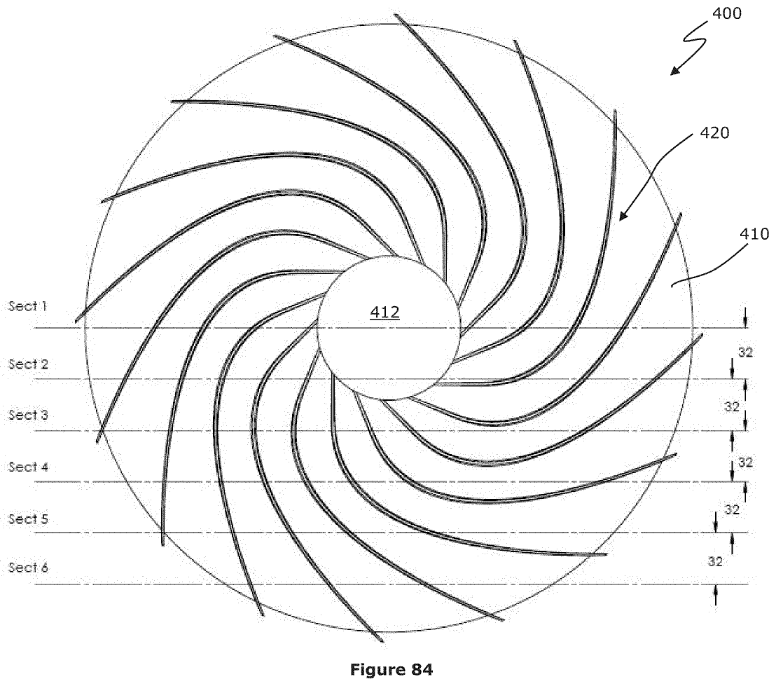

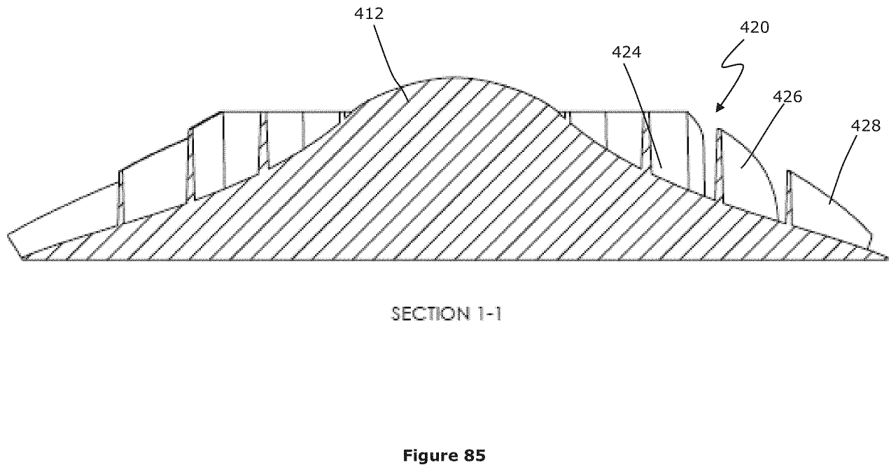

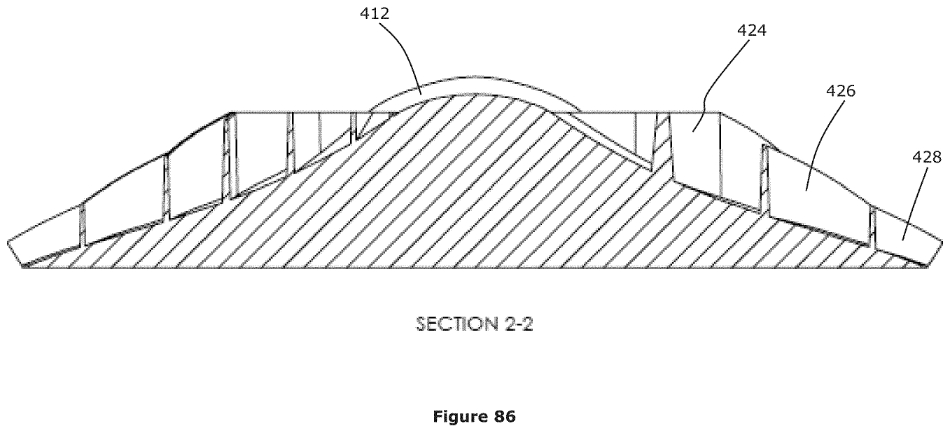

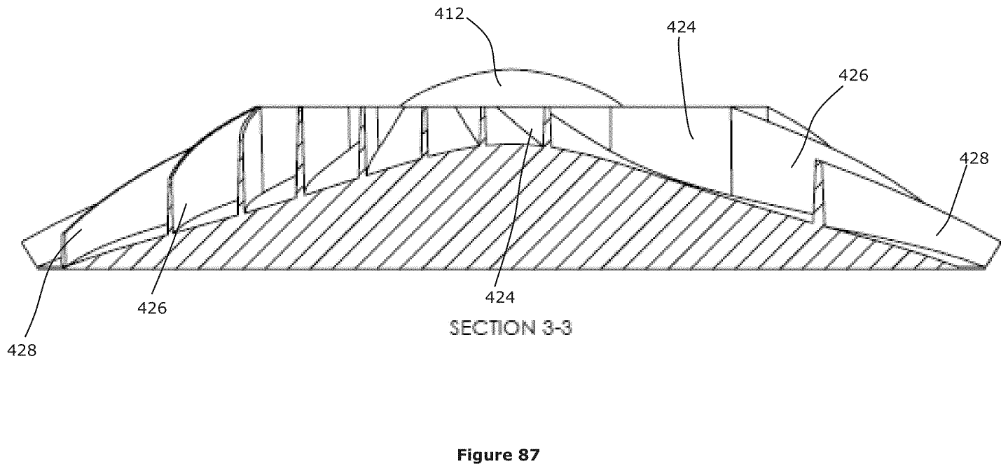

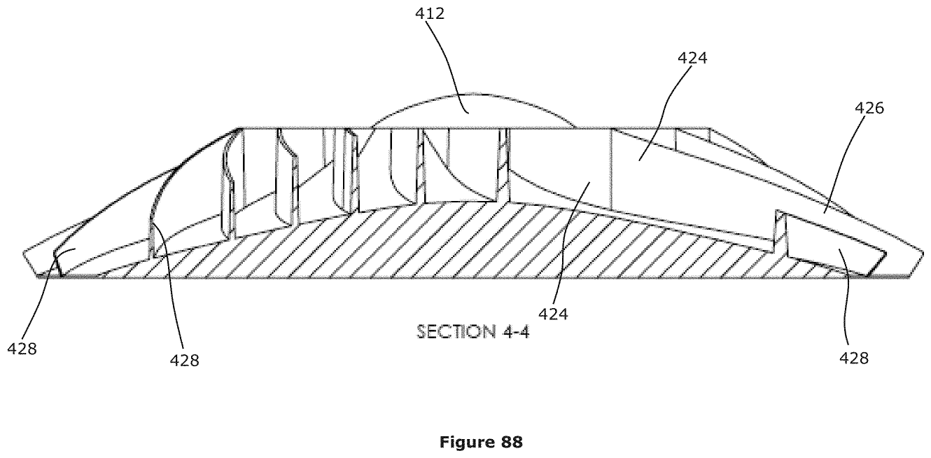

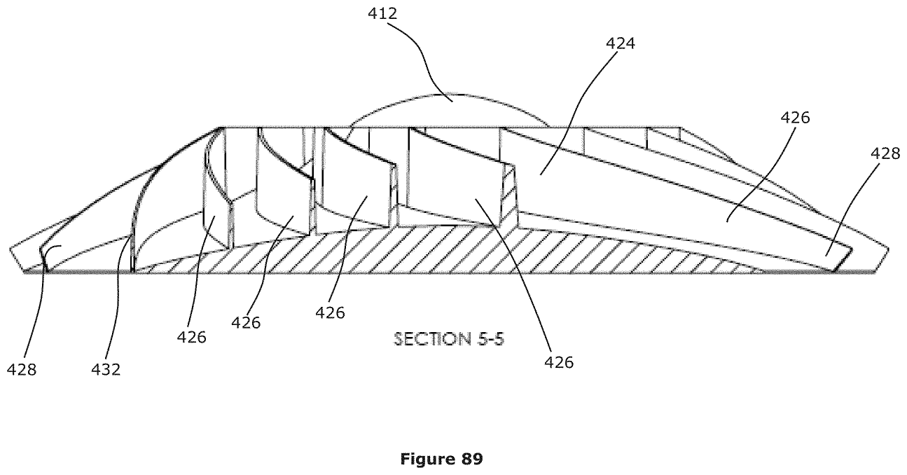

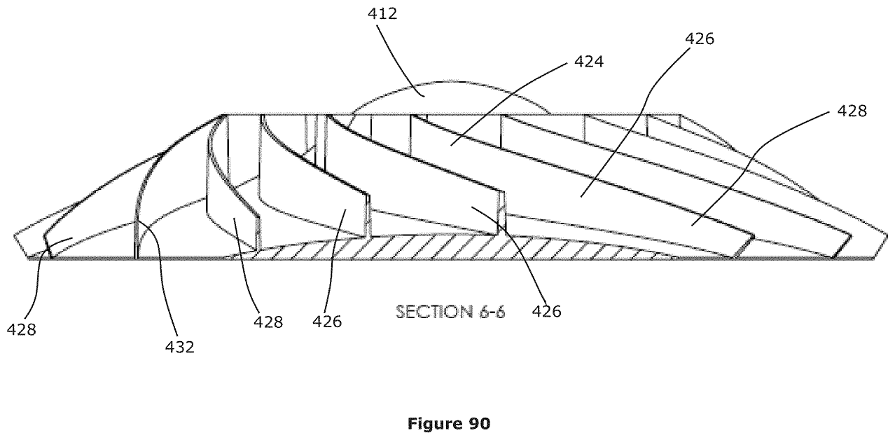

FIGS. 78 to 90 show another variant of the impeller 400 that is suitable as a standalone impeller 400 or for generating airflow for a ceiling fan assembly 100. The impeller 400 is similar in configuration with the R7 and R8 variants previously described, and comprises a rotatable impeller hub 410, which is mountable to the motor 120 by way of an impeller mount 402, to which the impeller hub 410 is fastened. The impeller hub 410 is of a general dome shape having a raised centre in the form of a hub dome 412 and the height of hub 410 transitions from its highest point at or about the hub dome 412 to its lowest point which is at the peripheral (circumferential) edge of the hub 410 (see FIG. 83).

The impeller 400 comprises a single set of continuous blades 420 positioned on the hub 410. Each continuous blade 420 extends from a blade root end 434, which is located closer to a central hub dome 412, radially outwards towards the hub peripheral edge 416 in an arcuate path. In the configuration as shown, each continuous blade 420 comprises three blade sections that follows an arcuate path; a first section that extends linearly towards the left side of the hub centre, a second section that curves substantially in an anti-clockwise direction when the impeller is viewed from above and a third section that extends substantially linearly towards the tip end 432 of the blade. It is to be appreciated that the reverse configuration would also be possible in other embodiments. Each blade is configured with a chord angle of between 30° and 40°. Each blade has, as measured at a top portion of its spine, a height that reduces along the length of the blade from the root end 434 to the blade's tip end 432. In some configurations, the height of the spine of each blade maintains a uniform height in a section that overlaps with the opening 222 or inlet vent 130 of the housing 200, when in use. Unlike the R7 and R8 impeller variants, the impeller 400 as shown in FIGS. 78 to 90 do not have a geometrical twist or “lean” along the length of each blade. Rather, each blade is configured to rise substantially vertically from the hub 410 as seen in sectional views shown in FIGS. 80, and 85 to 90. It has been determined that this design improves ease of manufacturing as no undercut moulding is required and the resulting impeller provides acceptable performances in comparison with the earlier described impeller variants.

### Further Embodiments

In one embodiment, the fan assembly 100 is advantageously provided with an integrated heater configured to heat the air streams inside the internal chamber 220. The heater may be in the form of a heating element or of any other suitable heater and provided with sensors and control circuitry for temperature control by a user. The heater unit is configured to be mountable to the fan assembly 100, preferably within the internal chamber 220, and connected to the same electrical system which powers the motor 120 and/or light fittings 242. In other configurations, heating elements may be located below the outer housing 200 or mounted to a bracket under the motor 120. The integrated heater works synergistically with the bladeless fan assembly 100 of the present invention as heated air streams in the internal chamber 220 and/or heated ambient air 190 around/under the outer housing 200 can be effectively circulated (and drawn, in the case of warm ambient air) by the high-volume and high-velocity laminar exit airflow resulting from the Coanda vanes working in series in the present invention. The incorporation of a heater in the fan assembly 100 advantageously allows the ceiling fan assembly 100 to be used in response to either warm or cool seasonal conditions—thereby extending the usefulness of the ceiling fan throughout the year.

Devices for filtering air can also be incorporated into the fan assembly 100. Membrane-based filters such as High Efficiency Particulate Air (HEPA) filters can be installed at the airflow inlet 224 and/or proximate the outlet passageway 168 to filter pollutant particles from air streams drawn into the internal chamber 220 or airflow downstream of the impeller 400, prior to the air being circulated external of the fan assembly 100. In one embodiment, filter members may be installed relative to the vent 130 of the airflow inlet 224 so that air can be filter upstream of the vent 130 or downstream of the vent 130 but before entering an inlet of the impeller 400. In some configurations, an air ioniser, which uses electrical charge to filter pollutant particles in the ambient air, can be incorporated into the fan assembly 100. In this regard, the air ioniser can be installed at the airflow inlet 224 and/or proximate the outlet passageway 168. An air filter and/or air ioniser will work synergistically with fan assemblies 100 embodying the present invention to improve air quality of the room in which the fan is located as the fan assembly 100 actively draws and entrains ambient air into the output airflow for filtration purposes. Details of the air filter and ioniser do not need to be described in detail as they can be the same as those commonly used in the art. The ioniser power and control units are configured to be mountable to the fan assembly 100, preferably within the internal chamber 220, and connected to the same electrical system which powers the motor 120 and/or light fittings 242.

Internet router and wireless connectivity capabilities can also be integrated into the fan assembly 100. In one embodiment, a suitable on-board wireless network (Wi-Fi) chipset and/or circuit board can be mounted below the motor 120 and connected to the same electrical system which powers the motor 120 and/or light fittings 242. It is to be understood that the wireless network chipset can be mounted internally or externally to the fan assembly 100 and located at any suitable mounting location so as to not have significant adverse influence on airflow characteristics of the fan assembly 100. Wireless network chipsets may include any suitable chipsets that are compatible with standard Wi-Fi signal relay and transmission, as well as features such as the ability to establish local connectivity networks (wireless hot spots) and/or signal repeaters. Details of the wireless chipset do not need to be described in detail as they can be the same as those commonly used in the art. Ceiling fans are ideal carriers for the location of Wi-Fi routers for the transmission and relay of wireless network data due to their typically elevated positions in a room (which enhances network coverage and reach through a property). The combination of wireless network capabilities and ceiling fans work synergistically as it makes improved use of ceiling mounting spaces and reduces the need for separate network devices/repeaters throughout a property, reduce clutter and provide an aesthetically attractive and multi-functional device. In another embodiment, a Bluetooth and/or Wi-Fi enabled speaker is installed under fan assembly 100 so that devices can connect via Bluetooth and/or Wi-Fi to emit surround sound to the occupants, as the centre of a room environment is an ideal location for occupants to listen to a speaker.

Power saving features may also be incorporated into a ceiling fan embodying the present invention. In particular, motion sensors in the form of infra-red, sonar or image sensors, or any other suitable sensors, can be mounted to a lower surface of the fan assembly 100 so as to detect movement or human activity within the room in which the fan assembly 100 is mounted or a target area. The fan assembly 100 can be programmed to be powered on automatically and provide airflow in accordance with predetermined settings when human activity/movement is detected in the room or the target area. In one configuration, the fan assembly 100 is programmed to be powered down or turned off when no activity has been detected for a predetermined period of time. In one embodiment, the motion sensor(s) for detecting movement and occupancy can be mounted to or incorporated within the light cover 240 and connected to the same electrical system which powers the motor 120 and/or light fittings 242.

Although the fan assembly 100 has been described to be applicable for use as a ceiling fan, it is to be understood that the fan assembly 100 can be equally suitable for use as a standing fan. In one embodiment, the fan assembly 100 is configured with reduced dimensions so as to be suitable for a table fan. In such embodiments, the down rod 140 can be coupled to a table mount having one or more arcuate arms which reach/contour(s) over the annular louvred vanes 300. The table mount comprises a base for seating the fan assembly 100 on a table. In an alternative embodiment, the down rod 140 is removed and the fan assembly 100 is provided with a vertical member that is configured to be coupled, integrally or otherwise, to the lower portion 230 of the fan assembly 100 or to the light fitting cover (if light fittings are provided). The vertical member is connected at an opposing end to a base, which seats the fan assembly 100 on a table. In an alternative embodiment, the fan assembly 100 can also be configured as a pedestal fan (free standing). In this embodiment, mounting mechanisms similar to that described in relation to the table fan can be applied to the fan assembly 100 when used as pedestal fan, except dimensions of the fan assembly 100, mounting mechanisms and pedestal bases will be adjusted accordingly. The fan assembly 100 can be rotated so that the airflow is directed to the direction that the occupant desires by means of a pivoting device connected to the vertical member. The techniques for incorporating a pivoting device in fan assembly or light fitting is known in the art and need not be described in detail.

Known techniques could also be adopted for reducing noise caused by the impeller 400 and airflows to and from the housing 200. The techniques for incorporating these features in fan assembly or light fitting is known in the art and need not be described in detail.

While aspects of the fan assembly have been described for use in combination with each other in the preferred embodiments of the present invention, it is to be understood by a skilled person that some aspects of the present invention are equally suitable for use between different fan embodiments and/or as standalone inventions that can be individually incorporated into fan assemblies, ceiling fans or standing fans not described herein.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

LIST OF PARTS

| | |
|---|---|
| fan/light | 2 |
| ceiling | 4 |
| housing | 6 |
| upper housing portion | 8 |
| Coanda surface | 10 |
| lower rim | 11 |
| base wall | 12 |
| light fitting | 13 |
| internal chamber | 14 |
| lower rim | 15 |
| impeller | 16 |
| impeller shaft | 18 |
| electric motor | 20 |
| bracket | 22 |
| curved skirt | 23 |
| bearing | 24 |
| upper surface | 25 |
| upper rim | 26 |
| inlet | 28 |
| outlet | 30 |
| impeller axis | 32 |
| stream of air | 34 |
| streams of entrained air | 36 |
| inlet passage | 38 |
| outlet passage | 39 |
| housing | 50 |
| flange | 52 |
| annular outlet passageway | 54 |
| first vane element | 56 |
| second vane element | 58 |
| leading edge | 60 |
| second Coanda surface | 64 |
| leading edge | 70 |
| trailing edge | 72 |
| trailing edge | 73 |
| third Coanda surface | 74 |
| modified fan/light | 78 |
| adjustable vanes | 80 |
| pivotal connections | 82 |
| axes | 84 |
| fan assembly | 100 |
| mounting plate | 110 |
| motor mounting bracket | 112 |
| motor | 120 |
| impeller shaft | 122 |
| vent | 130 |
| down rod | 140 |
| inlet airflow | 160 |
| annular outlet passageway | 168 |
| air outlet | 170 |
| outlet gap | 172 |
| primary airflow outlet | 174 |
| outflow air stream | 180 |
| Coanda airflow | 190 |
| entrained ambient airflow | 192 |
| primary outlet airflow | 194 |
| housing | 200 |
| upper housing portion | 210 |
| lower rim | 212 |
| upper rim | 214 |
| internal chamber | 220 |
| opening | 222 |
| airflow inlet | 224 |
| lower portion | 230 |
| light fitting cover | 240 |
| LED light fittings | 242 |
| housing collar | 250 |
| vane | 300 |
| sleeve | 302 |
| lower rim | 310 |
| upper rim | 320 |
| sloped blade | 330 |
| upper surface | 340 |
| Coanda surface | 342 |
| lower surface | 350 |
| leading edge | 360 |
| trailing edge | 370 |
| deflector | 390 |
| impeller | 400 |
| impeller mount | 402 |
| impeller hub | 410 |
| impeller hub dome | 412 |
| impeller hub opening | 414 |
| impeller hub periphery edge | 416 |
| impeller blade (continuous) | 420 |
| impeller blade (splitter) | 422 |
| split blade root portion | 423 |
| blade root portion | 424 |
| blade mid portion | 426 |
| blade end portion | 428 |
| impeller blade step | 430 |
| impeller blade tip end | 432 |
| blade tip projection | 433 |
| impeller blade root end | 434 |
| blade root portion spine | 442 |
| blade mid portion spine | 440 |
| blade tip portion spine | 444 |
| blade neutral point | 450 |

1.-25. (canceled)

26. A ceiling fan including:
a housing having an outlet;
an impeller located within the housing for producing a stream of air passing through the outlet;
a first Coanda surface positioned in or adjacent to the outlet and arranged such that said stream of air passes over the Coanda surface and wherein ambient air is, in use, entrained into said stream of air;
a second Coanda surface positioned adjacent to the first Coanda surface so that said stream of air leaving the first Coanda surface is directed to pass over the second Coanda surface.

27. The ceiling fan as claimed in claim 26, wherein the ceiling fan further comprises a first vane and a second vane mounted such that they are located, in use, in said stream of air, and wherein the first and second Coanda surfaces are respectively located on the first and second vanes.

28. The ceiling fan as claimed in claim 27, wherein the ceiling fan comprises additional one or more vanes mounted such that they are located, in use, in said stream of air.

29. (canceled)

30. The ceiling fan as claimed in claim 27, wherein the or each vane is coaxially mounted to the housing.

31. (canceled)

32. The ceiling fan as claimed in claim 27, wherein the or each vane is configured in the form of an annular frame.

33. The ceiling fan as claimed in claim 26, wherein the Coanda surfaces are concentric surfaces vertically arranged relative to each other.

34. The ceiling fan as claimed in claim 33, wherein at least one of the concentric surfaces is in the form of a concentric ring.

35. The ceiling fan as claimed in claim 33, wherein a downward extending angle of a higher Coanda surface is between about 20° and 25° relative to a vertical axis.

36. The ceiling fan as claimed in claim 33, wherein a downward extending angle of a lower Coanda surface is between about 30° and 35° relative to a vertical axis.

37. The ceiling fan as claimed in claim 26, wherein the Coanda surfaces are offset in a radial direction relative to each other.

38. The ceiling fan as claimed in claim 26, wherein the Coanda surfaces are disposed parallel with respect to each other and partially overlap when seen from a plan view.

39. (canceled)

40. The ceiling fan as claimed in claim 26, wherein one or more guide(s) are arranged in the outlet between adjacent Coanda surfaces so as to direct a stream of air to pass over a downstream Coanda surface in an outward direction.

41. (canceled)

42. The ceiling fan as claimed in claim 27, wherein the respective Coanda surface of the or each vane has a minimum width in a radial direction of about 390 mm.

43. The ceiling fan as claimed in claim 26, wherein at least one of the Coanda surfaces is convex in shape.

44. (canceled)

45. The ceiling fan as claimed claim 43, wherein a radius of a convex curvature is about 380 mm.

46. The ceiling fan as claimed in claim 26, wherein at least one of the Coanda surfaces is flat.

47. The ceiling fan as claimed in claim 46, wherein all Coanda surfaces are flat.

48. The ceiling fan as claimed in claim 26, wherein the Coanda surfaces extend downwardly with an angle of less than 90° relative to a vertical axis.

49. (canceled)

50. The ceiling fan as claimed in claim 26, wherein an opening of the outlet has a height of about 20 mm or less.

51. The ceiling fan as claimed in claim 26, including mounting means for mounting the ceiling fan to a ceiling and an inlet which is, in use, located adjacent to the ceiling, and the inlet is located above an impeller for drawing ambient air in a downward direction toward the impeller.

52.-71. (canceled)
